(19) United States
(12) Patent Application Publication
(10) Pub. No.: US 2019/0168197 A1
(43) Pub. Date: Jun. 6, 2019

(54) Synthetic Zeolite Comprising A Catalytic Metal

(71) Applicants: Avelino CORMA CANOS, Valencia (ES); Javier GUZMAN, Porter, TX (US); Manuel MOLINER MARIN, Valencia (ES); Pedro M. SERNA MERINO, Branchburg, NJ (US); Karl G. STROHMAIER, Port Murray, NJ (US)

(72) Inventors: Avelino CORMA CANOS, Valencia (ES); Javier GUZMAN, Porter, TX (US); Manuel MOLINER MARIN, Valencia (ES); Pedro M. SERNA MERINO, Branchburg, NJ (US); Karl G. STROHMAIER, Port Murray, NJ (US)

(73) Assignee: ExxonMobil Chemical Company - Law Technology, Baytown, TX (US)

(21) Appl. No.: 16/097,775

(22) PCT Filed: May 24, 2017
(86) PCT No.: PCT/EP2017/000621

§ 371 Date: Oct. 30, 2018

Related U.S. Application Data
(60) Provisional application No. 62/340,768, filed on May 24, 2016.

(30) Foreign Application Priority Data
Aug. 11, 2016 (EP) 16183679.6

(51) Int. Cl. B01J 29/76; B01J 29/74; B01J 29/04; B01J 37/00; B01J 37/04; B01J 37/03; B01J 20/18; B01J 20/02; B01J 20/30

(52) U.S. Cl. CPC B01J 29/763; B01J 29/743; B01J 29/74; B01J 29/043; B01J 37/0018; B01J 37/04; B01J 2229/186; B01J 20/18; B01J 20/0225; B01J 20/0229; B01J 20/3085; B01J 20/3057; B01J 37/031

(57) ABSTRACT

A small pore size synthetic zeolite having a degree of crystallinity of at least 80% and comprising at least 0.01 wt % based on the weight of the zeolite of at least one catalytic metal selected from the group consisting of Ru, Rh, Pd, Ag, Os, Ir, Pt, Au, Mo, W, Re, Co, Ni, Zn, Cr, Mn, Ce, Ga and combinations thereof, wherein at least 80% of the catalytic metal is encapsulated in the zeolite, wherein if the zeolite is an aluminosilicate it has a SiO₂:Al₂O₃ molar ratio of greater than 6:1.

### CROSS-REFERENCES TO RELATED APPLICATIONS

The present application claims priority to and the benefit of U.S. Ser. No. 62/340,768, filed May 24, 2016, and European Patent Application Serial No. 16183679.6, filed Aug. 11, 2016, which are all incorporated herein by reference.

### FIELD OF THE INVENTION

The present invention relates to a small pore synthetic zeolite comprising a catalytic metal and to processes for making the small pore synthetic zeolite.

### BACKGROUND OF THE INVENTION

Zeolites are a class of crystalline microporous oxide materials with well-defined pores and cavities. Although their chemical composition was first limited to aluminosilicate polymorphs, many more heteroatoms such as B, P, As, Sn, Ti, Fe, Ge, Ga, Be and Zn, among others, can now be introduced into zeolitic frameworks in addition to Si and Al.

Zeolites, both natural and synthetic, have been demonstrated in the past to be useful as adsorbents and to have catalytic properties for various types of hydrocarbon conversion reactions. Zeolites are ordered, porous crystalline materials having a definite crystalline structure as determined by X-ray diffraction (XRD). Within the crystalline zeolite material there are a large number of cavities which may be interconnected by a number of channels or pores. These cavities and pores are uniform in size within a specific zeolite material. Because the dimensions of these pores are such as to accept for adsorption molecules of certain dimensions while rejecting those of larger dimensions, these materials are utilized in a variety of industrial processes.

Zeolites can be described as rigid three-dimensional framework of TO₄ tetrahedra (T=Si, Al, P, Ti, etc.). The tetrahedra are cross-linked by the sharing of oxygen atoms with the electrovalence of the tetrahedra containing trivalent element (e.g., aluminum or boron) or divalent element (e.g., Be or Zn) being balanced by the inclusion in the crystal of a cation, for example, a proton, an alkali metal or an alkaline earth metal cation. This can be expressed wherein the ratio of the Group 13 element (e.g., aluminum or boron) to the number of various cations, such as H⁺, Ca²⁺*2, Sr²⁺*2, Na⁺, K⁺, or Li⁺, is equal to unity.

Zeolites that find application in catalysis include any of the naturally occurring or synthetic crystalline zeolites. Examples of these zeolites include large pore zeolites, intermediate pore size zeolites, and small pore zeolites. These zeolites and their isotypes are described in “Atlas of Zeolite Framework Types”, eds, Ch. Baerlocher, L. B. McCusker. D. H. Olson, Elsevier, Sixth Revised Edition, 2007, which is hereby incorporated by reference. A large pore zeolite generally has a pore size of at least about 6.0 Å to 8 Å and includes LTL, MAZ, FAU, OFF, *BEA, and MOR framework type zeolites (IUPAC Commission of Zeolite Nomenclature). Examples of large pore zeolites include mazzite, offretite, zeolite L, zeolite Y, zeolite X, omega, and beta. An intermediate pore size zeolite generally has a pore size from more than 4.5 Å to less than about 7 Å and includes, for example, MFI, MEL, EUO, MTT, MFS, AEL, AFO, HEU, FER, MWW, and TON framework type zeolites (IUPAC Commission of Zeolite Nomenclature). Examples of intermediate pore size zeolites include ZSM-5, ZSM-11, ZSM-22, MCM-22, silicalite 1, and silicalite 2. A small pore size zeolite has a pore size from about 3 Å to less than about 5.0 Å and includes, for example, CHA, ERI, KFI, LEV, SOD, and LTA framework type zeolites (IUPAC Commission of Zeolite Nomenclature). Examples of small pore zeolites include ZK-4, SAPO-34, SAPO-35, ZK-14, SAPO-42, ZK-21, ZK-22, ZK-5, ZK-20, zeolite A, chabazite, zeolite T, and ALPO-17.

Synthesis of zeolites typically involves the preparation of a synthesis mixture which comprises sources of all the elements present in the zeolite, often with a source of hydroxide ion to adjust the pH. In many cases a structure directing agent (SDA) is also present. Structure directing agents are compounds which are believed to promote the formation of zeolite frameworks and which are thought to act as templates around which certain zeolite structures can form and which thereby promote the formation of the desired zeolite. Various compounds have been used as structure directing agents including various types of quaternary ammonium cations.

The synthesis of zeolites is a complicated process. There are a number of variables that need to be controlled in order to optimize the synthesis in terms of purity, yield and quality of the zeolite produced. A particularly important variable is the choice of synthesis template (structure directing agent), which usually determines which framework type is obtained from the synthesis. Quaternary ammonium ions are typically used as the structure directing agents in the preparation of zeolite catalysts. For example, zeolite MCM-68 may be made from quaternary ammonium ions as is described in U.S. Pat. No. 6,049,018. Other known zeolites that are typically produced using quaternary ammonium ions include ZSM-25, ZSM-48, ZSM-57, ZSM-58, and ECR-34, as described in U.S. Pat. Nos. 4,247,416, 4,585,747, 4,640,829, 4,698,218, and 5,455,020.

The “as-synthesized” zeolite will contain the structure directing agent in its pores, and is usually subjected to a calcination step to burn out the structure directing agent and free up the pores. For many catalytic applications, it is also desirable to include metal cations such as metal cations of Groups 2 to 15 of the Periodic Table of the Elements within the zeolite structure. This is typically accomplished by ion exchange treatment.

Zeolites are often used in industrial catalysts as supports for catalytic metals. Such catalytic metals, for example platinum and rhodium, are key components of refinery catalysts, as they enable the activation of C—H, H—H and C═C bonds, amongst others. Metals also play an important role in palliating catalyst deactivation by coke in acid catalyzed processes, using hydrogen to maintain the catalyst surface clean of heavy hydrocarbons. At the high operating temperatures of these transformations, and in the presence of strong reductants such as hydrogen, a major problem emerges due to gradual reorganization of the metal into the form of larger (thermodynamically more stable) metal particles, which implies a loss in the effective number of sites available for catalysis. Moreover, hydroprocessing catalysts often require periodic regeneration routines to eliminate residual heavy hydrocarbons from the catalyst surface, using air and high temperatures to complete the combustion process. The use of H₂/O₂ cycles along the catalyst lifetime aggravates the metal sintering problem.

Currently a number of methods are available for the production of metal catalysts supported on zeolites. Today, most supported metal catalysts are prepared by ion exchange or incipient wetness impregnation of the support. In each case the goal is to place the metal inside the pores of the support without an agglomeration of metal particles on the external surface of the support. Since the metals are typically introduced as cation precursors, they can ion exchange with the cations associated with the ionic framework, in particular with the trivalent elements, such as Al in an aluminosilicate material, or tetravalent elements such as Si in a silicoaluminophosphate material. The association of the positively charged metal cation with negatively charged anionic sites within the pores and/or cavities of the zeolite allows for an initial high dispersion of the metal. However, if the metal precursor is multiply charged, then the process becomes less efficient unless the support contains a higher density of anionic sites to charge balance the metal cations. As a result, it becomes more difficult to load multiply charged metal cations into zeolites with a lower number of anionic sites. It would however be desirable to incorporate metals inside higher silica supports.

It is also desirable to have new metal catalysts able to resist common refinery poisons such as sulphur, nitrogen or phosphorous containing contaminants. Provision of such poison resistant metal catalysts would allow a reduction in equipment designed to remove those poisons from feed streams and/or would increase the life of the catalyst.

### SUMMARY OF THE INVENTION

In one aspect the invention provides a small pore size synthetic zeolite having a degree of crystallinity of at least 80% and comprising at least 0.01 wt %, based on the weight of the zeolite, of at least one catalytic metal selected from the group consisting of Ru, Rh, Pd, Ag, Os, Ir, Pt, Au, Mo, W, Re, Co, Ni, Zn, Cr, Mn, Ce, Ga, and combinations thereof, wherein at least 80% of the catalytic metal is encapsulated in the zeolite, wherein if the zeolite is an aluminosilicate then the aluminosilicate has a SiO₂:Al₂O₃ molar ratio of greater than 6:1, preferably greater than 12:1, in particular greater than 30:1.

In yet a further aspect the invention provides a small pore size synthetic aluminosilicate zeolite having a SiO₂:Al₂O₃ molar ratio of greater than 6:1, preferably greater than 12:1, in particular greater than 30:1, and a degree of crystallinity of at least 80% which comprises at least 0.01 wt %, based on the weight of the zeolite, of at least one catalytic metal selected from the group consisting of Ru, Rh, Pd, Ag, Os, Ir, Pt, Au, Mo, W, Re, Co, Ni, Zn, Cr, Mn, Ce, Ga, and combinations thereof, wherein at least 80% of the catalytic metal is encapsulated in the zeolite.

In another aspect the invention provides a small pore size synthetic zeolite having a degree of crystallinity of at least 80% and comprising at least 0.01 wt %, based on the weight of the zeolite, of at least one catalytic metal selected from the group consisting of Ru, Rh, Pd, Ag, Os, Ir, Pt, Au, Mo, W, Re, Co, Ni, Zn, Cr, Mn, Ce, Ga, and combinations thereof, wherein at least a portion of the catalytic metal is encapsulated in zeolite such that if the zeolite is used to catalyze the conversion of a feed stream containing a first reactant compound which is sufficiently small that it can enter the pores of the zeolite (e.g. ethylene) and a second reactant compound which is sufficiently large that it cannot enter the pores of the zeolite (e.g. propylene), then the ratio of the rate of conversion of the second reactant to the rate of conversion of the first reactant is reduced by at least 80% as compared to the same reaction carried out under the same conditions using the same feed stream over a catalyst comprising the same catalytic metal supported on the surface of an amorphous support, wherein if the zeolite is an aluminosilicate then the aluminosilicate has a SiO₂:Al₂O₃ molar ratio of greater than 6:1, preferably greater than 12:1, in particular greater than 30:1.

The invention also provides, in yet a further aspect, a process for the preparation of the small pore size synthetic zeolite of the invention comprising:

a) providing a reaction mixture comprising a synthesis mixture capable of forming the small pore size synthetic zeolite framework and at least one catalytic metal precursor, wherein the catalytic metal precursor includes metal complexes stabilized by ligands L selected from the group consisting of N-containing ligands, O-containing ligands, S-containing ligands, and P-containing ligands;

b) heating said reaction mixture under crystallization conditions to form crystals of said small pore size synthetic zeolite; and

c) recovering said crystals of the small pore size synthetic zeolite from the reaction mixture.

The invention, in yet a further aspect, also provides a process for the preparation of a small pore size synthetic zeolite of the invention comprising:

a) providing a reaction mixture comprising a synthesis mixture capable of forming to the small pore size synthetic zeolite framework, at least one anchoring agent, and at least one catalytic metal precursor, wherein the anchoring agent includes at least one amine and/or thiol group and at least one alkoxysilane group and the catalytic metal precursor includes at least one ligand capable of being exchanged by the at least one amine group and/or thiol group of the anchoring agent;

b) heating said reaction mixture under crystallization conditions to form crystals of said small pore size synthetic zeolite; and

c) recovering said crystals of the small pore size synthetic zeolite from the reaction mixture.

Where the synthesis mixture comprises a structure directing agent (SDA), the crystals of the small pore size synthetic zeolite recovered from the reaction mixture will include the SDA in the pores and cavities of the zeolite (that is, in “as made” form). The processes for the preparation of the small pore size synthetic zeolite of the invention may further include a step of subjecting the small pore size synthetic zeolite recovered from the reaction mixture to a calcination step. The calcination step removes the structure directing agent and provides the zeolite in calcined form. The calcination step also removes the ligands or anchoring agents used to stabilize the metal during the crystallization step.

In yet a further aspect, the invention provides use of an active form of the small pore size synthetic zeolite of the invention as a sorbent or as a catalyst. By active form is meant a calcined material that has been ion-exchanged with protons and is therefore acidic.

In yet a further aspect, the invention provides a process for converting a feedstock comprising an organic compound to a conversion product which comprises the step of contacting said feedstock at organic compound conversion conditions with a catalyst comprising a small pore size synthetic zeolite according to the invention.

### BRIEF DESCRIPTION OF THE DRAWINGS

FIG. 1 shows PXRD patterns of the metal-containing high-silica small pore zeolites synthesized according to Examples 1 and 4 to 10.

FIG. 2 shows TEM images and particle size distributions of the sample synthesized according to Example 1, after being calcined at 550° C., and treated with H₂ at 400° C. (FIGS. 2A and 2C), and after additional thermal treatment by calcination with air at 650° C., and subsequent reduction with H₂ at 400° C. (FIGS. 2B and 2D).

FIG. 3 shows the XANES and EXAFS spectra of the sample synthesized according to Example 1. FIG. 3A shows XANES spectra of the sample synthesized according to Example 1 (after being calcined at 550° C., and treated with H₂ at 400° C.) (time zero, bottom spectrum), as the sample is further treated with 5% O₂ and the temperature is raised from 20 to 500° C. FIG. 3B shows EXAFS spectra (not phase-corrected) of the oxidised sample after the oxidation detailed for FIG. 3A (bottom line), and its comparison with the material of Example 1 (calcined at 550° C., and treated with H₂ at 400° C.) (middle line), and a reference platinum foil (top line).

FIG. 4 shows STEM images and particle size distributions of the sample synthesized according to Comparative Example 2 after being calcined at 400° C., and treated with H₂ at 400° C. (FIGS. 4A and 4C), and after additional thermal treatment by calcination with air at 650° C., and, finally, with H₂ at 400° C. (FIGS. 4B and 4D).

FIG. 5 shows the initial reaction rates obtained for the hydrogenation of model alkenes (ethylene and propylene) using the materials synthesized according to Example 1 and Comparative Example 2 as catalysts.

FIG. 6 shows TEM images of the sample synthesized according to Example 4, after calcination at 550° C. followed by treatment with H₂ at 400° C. FIG. 6A is representative of the majority of the areas evaluated, showing small metal nanoparticles. FIG. 6B shows an area where a big metal nanoparticle is observed in addition to the small metal nanoparticles (the abundance of the larger particles is <0.1% by number).

FIG. 7 shows TEM images and particle size distribution of the sample synthesized according to Example 5, after being calcined at 600° C., and treated with H₂ at 400° C. (FIG. 7A), and after additional thermal treatment by calcination with air at 650° C., and subsequent reduction with H₂ at 400° C. (FIGS. 7B and 7C).

FIG. 8 shows the Fourier-Transform EXAFS spectra (not phase-corrected) at the Rh K-Edge of the sample synthesized according to Example 6 after treatment with 5% O₂ at 500° C.

FIG. 9 shows TEM images of the sample synthesized according to Example 8, after being calcined at 500° C., and treated with H₂ at 400° C. (FIG. 9A), and after additional thermal treatment by calcination with air at 650° C., and subsequent reduction with H₂ at 400° C. (FIG. 9B).

FIG. 10 shows TEM images and particle size distribution of the sample synthesized according to Example 9, after being calcined at 560° C., and treated with H₂ at 400° C. (FIG. 10A), and after additional thermal treatment by calcination with air at 650° C., and subsequent reduction with H₂ at 400° C. (FIGS. 10B and 10C).

FIG. 11 shows a STEM image and particle size distribution of a microtomed to sample synthesized according to Example 10, after being calcined at 550° C., and treated with H₂ at 400° C. (FIGS. 11A and 11B).

FIGS. 12 and 13 show a STEM image and EXAFS spectra of the sample synthesized according to Example 11, after being calcined at 550° C., and treated with H₂ at 400° C. FIG. 13 shows the Fourier-Transform EXAFS spectra (not phase-corrected) at the Pt LIII-Edge (FIG. 13A top) and Pd K-Edge (FIG. 13A bottom) of said sample and the EXAFS spectra (not phase-corrected) at the Pt LIII-Edge (FIG. 13B top) and Pd K-Edge (FIG. 13B bottom) of said sample after treatment with SO₂ at 500° C.

FIG. 14 shows a STEM image of the sample synthesized according to Example 12, after being calcined at 550° C., and treated with H₂ at 400° C.

FIG. 15 shows SEM (retro-dispersed electrons) images of the sample synthesized according to Example 1 (top) and Comparative Example 13 (bottom) after calcination at 550° C. (left) and after subsequent treatment in steam at 600° C. (right).

FIG. 16 shows PXRD patterns of sample synthesized according to Example 1 (top) and Comparative Example 13 (bottom) after calcination at 550° C. (left) and after subsequent treatment in steam at 600° C.

### DETAILED DESCRIPTION OF THE INVENTION

The present inventors have found that it is possible to synthesize small pore size zeolites, in particular silicates and aluminosilicates, having a catalytic metal present in encapsulated form inside the pores and/or cavities of the zeolite. Without wishing to be bound by theory, the inventors believe that the encapsulation of the catalytic metal within the small pore size synthetic zeolites, in particular within the pores and/or cavities of small pore size synthetic zeolites, limits the growth of the catalytic metal species to small particles, for example, catalytic metal particles having a biggest dimension of less than 4.0 nm, for instance a biggest dimension in the range between 0.1 and 3.0 nm, such as between 0.5 and 1.0 nm, and prevents significant growth of those particles thereby providing an improved resistance to sintering. The size of the particles of catalytic metal (at least in terms of biggest dimension) is typically larger than the pore window size of the zeolite, and so the metal can be considered to be occluded within the cavities in the zeolite crystals rather than being present in the small pore windows of the zeolite. Conventional noble metal catalysts on silica supports, in contrast, generally exhibit sintering and therefore growth of the metal particles under high temperature cycles of reduction and oxidation which leads to a reduction in the number of catalytic sites and the activity of the catalyst. In addition, the zeolites of the invention may have advantages in selectivity in organic conversion reactions and in resistance to catalyst poisons.

The term “synthetic zeolite” should be understood to refer to a zeolite which has been prepared from a synthesis mixture as opposed to being a naturally occurring zeolite which has been obtained by mining or quarrying or similar processes from the natural environment.

The term “small pore size synthetic zeolite” as used herein refers to a synthetic zeolite wherein the pores of the zeolite have a size in the range of from 3.0 Å to less than 5.0 Å. The small pore size synthetic zeolite will generally have an 8-membered ring framework structure but some 9- or 10-membered ring zeolites are known to have distorted rings which have a size in the range of from 3.0 to 5.0 Å and fall within the scope of the term “small pore size synthetic zeolite” as used herein. Optionally, the small pore size synthetic zeolite is an 8-membered ring zeolite. A number of 8-membered ring zeolites are listed in the “Atlas of Zeolite Framework Types”, eds, Ch. Baerlocher, L. B. McCusker, D. H. Olson, Elsevier, Sixth Revised Edition, 2007.

Optionally, the small pore size synthetic zeolite is of framework type AEI, AFT, AFX, CHA, CDO, DDR, EDI, ERI, IHW, ITE, ITW, KFI, MER, MTF, MWF, LEV, LTA, PAU, PWY, RHO, SFW or UFI, more preferably of framework type CHA, AEI, AFX, RHO, KFI or LTA. Optionally, the small pore synthetic zeolite is of framework type CHA or AFX. CHA is an especially preferred framework type. The zeolite framework type may optionally be a framework type which can be synthesized without requiring the presence of a structure directing agent. In an alternative embodiment the small pore size synthetic zeolite may be of a framework type which requires the presence of a structure directing agent in the synthesis mixture.

Optionally the small pore size synthetic zeolite is one in which the zeolite framework contains one or more elements selected from the group consisting of Si, Al, P, As, Ti, Ge, Sn, Fe, B, Ga, Be and Zn; preferably in which the zeolite framework contains at least one tetravalent element X selected from the group consisting of Si, Ge, Sn and Ti and/or at least one trivalent element Y selected from the group consisting of Al, B, Fe and Ga, optionally one pentavalent element Z selected from the group consisting of P and As, and optionally one divalent element W selected from the group consisting of Be and Zn; more preferably in which the zeolite framework contains at least Si and/or Al and optionally P.

In a preferred embodiment, the zeolite framework contains at least one tetravalent element X selected from the group consisting of Si, Ge, Sn and Ti and optionally at least one trivalent element Y selected from the group consisting of Al, B, Fe and Ga; most preferably the zeolite framework contains Si and optionally Al and/or B; especially the zeolite framework contains Si and optionally Al. Where the zeolite framework contains a metal, such as Fe, the catalytic metal and transition metal will be other than the metal contained in the framework. Typically, the catalytic metal is extra-framework metal, that is, the catalytic metal generally does not form part of the framework of the synthetic zeolite, i.e. of the three-dimensional framework of tetrahedra of the synthetic zeolite.

Optionally, the small pore size synthetic zeolite is selected from the group consisting of silicates, aluminosilicates, borosilicates, aluminophosphates (ALPOs), and silicoaluminophosphates (SAPOs); preferably from silicates, aluminosilicates and borosilicates, especially from silicates and aluminosilicates.

The small pore size synthetic zeolite may optionally be a crystalline aluminophosphate or silicoaluminophosphate. Aluminophosphate molecular sieves are porous frameworks containing alternating aluminum and phosphorous tetrahedral atoms connected by bridging oxygen atoms. In the case of silicoaluminophosphate molecular sieves, some of the phosphorous, or pairs of aluminum and phosphorous atoms can be substituted with tetrahedral silicon atoms. Those materials may be represented by the formula, on an anhydrous basis:

mSDA:(SiₓAl_{y}P_{z})O₂

m in the number of moles of SDA per mole of (SiₓAl_{y}P_{z})O₂ and m has a value in the as-synthesized form from 0.01 to 0.5, preferably from 0.04 to 0.35; x, y, and z respectively represent the mole fraction of Si, Al and P as tetrahedral oxides, where x+y+z=1, and y and z are greater than or equal to 0.25. Preferably, x is greater than 0 in the case of silicoaluminophosphate molecular sieves and optionally, x is in the range of from greater than 0 to about 0.31. The range of y is from 0.25 to 0.5, and z is in the range of from 0.25 to 0.5 and preferably y and z are in the range 0.4 to 0.5.

The small pore size synthetic zeolite is preferably a silicate or an aluminosilicate. If the small pore size synthetic zeolite is an aluminosilicate, it contains Si and Al and has a SiO₂:Al₂O₃ molar ratio of greater than 6:1, preferably greater than 8:1, more preferably greater than 10:1, most preferably greater than 12:1, in particular greater than 30:1, such as greater than 100:1, or even greater than 150:1. If the small pore size synthetic zeolite is a silicate, it has an Al₂O₃:SiO₂ molar ratio that is 0 or a SiO₂:Al₂O₃ molar ratio that is infinite (i.e. no Al₂O₃). While the presence of aluminum within the zeolite framework structure does contribute acidic sites to the catalyst it also is associated with a reduction in thermal stability of the zeolite. Many industrial organic feedstock conversion processes are carried out at temperatures which require the use of zeolite supports having a SiO₂:Al₂O₃ molar ratio of greater than 6:1 or even greater than 10:1, such as greater than 12:1 or greater than 30:1 or greater than 100:1 or greater than 150:1.

The small pore size synthetic zeolite has a degree of crystallinity of at least 80%, optionally at least 90%, preferably at least 95% and most preferably at least 98%. In one embodiment the small pore size synthetic zeolite is essentially pure crystalline material. The degree of crystallinity may be calculated via x-ray diffraction (XRD) by comparison with a reference material of known 100% crystalline material of the same framework type, the same composition, the same or similar particle size and containing the same amount of metals prepared by an incipient wetness technique. The catalytic metal is primarily extra-framework metal and is in the form of metal particles that will tend to scatter x-rays. Therefore in order to obtain fully comparable results to calculate the degree of crystallinity it is important that the reference material contains the same amount of the same metals as present in the small pore size synthetic zeolite.

The small pore size synthetic zeolite comprises at least 0.01 wt % of catalytic metal, based on the weight of the zeolite. The amount of metal is determined by X-ray fluorescence (XRF) or inductively coupled plasma (ICP) and is expressed as wt % of the metal (based on the elemental form of the metal, and not, for example, the oxide form) in the total sample. Optionally, the small pore size synthetic zeolite comprises at least 0.05 wt %, preferably from 0.05 to 5 wt % of the catalytic metal, preferably from 0.1 to 3 wt %, more preferably from 0.5 to 2.5 wt %, most preferably from 1 to 2 wt %.

The weight percentage of the catalytic metal which is encapsulated in the zeolite can be calculated by carrying out an organic conversion reaction involving a mixed feed having at least one feed compound which is small enough to enter the pores of the zeolite and at least one feed compound which is too large to enter the pores of the zeolite and by comparing the results with an equivalent reaction carried out using a catalyst having an equivalent metal loading in which the metal is not encapsulated, for example one in which the metal is supported on amorphous silica. For example, for a hydrogenation catalyst the weight percentage of the catalytic metal which is encapsulated in the zeolite may be measured by hydrogenation of a mixed feed comprising a feed compound, such as ethylene, which is small enough to enter the pores of the zeolite and a feed compound, such as propylene, which is too large to enter the pores of the zeolite. Preferably, the smaller compound (e.g. ethylene) and larger compound (e.g. propylene) may be reacted independently rather than as a mixed feed comprising both. This is advantageous in that it avoids competitive adsorption and diffusion effects that may occur when the smaller and larger compounds are co-fed. Such a procedure is described in detail in Example 3 below. For the catalysts of the invention, the conversion of the larger molecule, for example propylene, will be slower than the conversion of the smaller molecule, for example ethylene, relative to the reference catalyst and the degree of difference can be used to calculate the percentage of catalytic metal which is encapsulated. It should be recognized that this method only takes into account the catalytic metal present in the zeolite of the invention, i.e. the extra-framework metal that has a catalytic activity. For example, the bulk metal inside any large metal particles present or any catalytic metal covered under dense SiO₂ layers will not take part in the reaction and so will not influence the selectivity and the product mix obtained. For that reason, the words “at least 80% of the catalytic metal is encapsulated in the zeolite” and similar expressions should be taken to mean “at least 80% of the catalytically active portion of the catalytic metal is encapsulated in the zeolite”, it being understood that in many cases the catalytically active portion of the catalytic metal will be all or substantially all of the catalytic metal.

In an especially preferred embodiment, the percentage of the active catalytic metal that is encapsulated in the zeolite (α) is determined by the following formula:

$$α = \frac{[ \frac{PR SiO 2}{ER SiO 2} - \frac{PR zeolite}{ER zeolite} ]}{[ \frac{PR SiO 2}{ER SiO 2} ]} * 100$$

wherein α is the percentage of catalytic metal encapsulated in the zeolite, PR is the propylene reaction rate expressed as mol of propylene converted per mol of catalytic metal per second, ER is the ethylene reaction rate expressed as mol of ethylene converted per mol of catalytic metal per second, “PR zeolite” and “ER zeolite” are to be understood as the propylene and ethylene rates of conversion for the catalyst to be tested, and “PR SiO₂” and “ER SiO₂” are to be understood as the propylene and ethylene rates of conversion for a catalyst having an equivalent metal loading in which the metal is supported on amorphous silica. All terms in the formula relate to the total amount of catalytic metal which appears each time in the numerator and in the denominator of each fraction. Therefore, a is an absolute percentage number, and it does not matter whether the amount of metal is expressed as amounts in weight or mole.

Based on the above-referenced formula, an a of at least 80% corresponds to an ethylene hydrogenation rate that is at least 5 times greater than that of propylene for metals that hydrogenate both ethylene and propylene at identical rates when supported on SiO₂.

Optionally, greater than 80%, more preferably at least 90%, more preferably at least 95%, and most preferably at least 98% of the catalytic metal is encapsulated in the zeolite of the present invention. In an especially preferred embodiment, at least 90° %, more particularly at least 95% of the catalytic metal is encapsulated in the zeolite of the present invention.

The catalytic metal may be selected from group consisting of Ru, Rh, Pd, Ag, Os, Ir, Pt, Au, Mo, W, Re, Co, Ni, Zn, Cr, Mn, Ce, Ga, and combinations thereof; more preferably from the group consisting of Ru, Rh, Pd, Ag, Os, Ir, Pt, Au, Re, and combinations thereof; most preferably from the group consisting of Pt, Rh, Pd and Au and combinations thereof, especially from the Pt, Pd and/or Rh. Pt and Rh are especially preferred catalytic metals.

Typically, the catalytic metal will be present in the form of metal particles, which includes metal clusters as well as site-isolated single metal atoms (the catalytic metal may be present in the particles and/or clusters as elemental metal or as the metal oxide). Optionally, the catalytic metal is present in the form of particles wherein at least 80% of the particles by number have a biggest dimension of less than 4 nm as measured by transmission electron microscopy (TEM). Preferably at least 80% of the particles by number have a biggest dimension in the range of from 0.1 to 3.0 nm, for instance from 0.5 to 1 nm, as measured by TEM. In the context of the present application, the expression “percentage of the particles by number” refers to the arithmetic average of number of particles having the required characteristic out of 100 particles, this value being determined on the basis of a population of at least one thousand particles. In the present application, the expression “biggest dimension” when discussing metal particle size means the biggest dimension as measured by TEM. In the case of substantially spherical particles, the biggest dimension of a particle will correspond to its diameter. In the case of rectangular particles, the biggest dimension of a particle will correspond to the diagonal of the rectangle drawn by the particle. In an especially preferred embodiment, after thermal treatment of the small pore size synthetic zeolite of the present invention by calcination in air at 650° C. for two hours and treatment with H₂ at 400° C. for two hours, the catalytic metal will still be present in the form of particles wherein at least 80% of the particles by number have a biggest dimension of less than 4 nm as measured by TEM, in particular at least 80% of the particles by number will still have a biggest dimension in the range of from 0.1 to 3.0 nm, for instance from 0.5 to 1 nm, as measured by TEM.

The small pore size synthetic zeolite may further comprise one or more metals other than the catalytic metal. Optionally, the small pore size synthetic zeolite comprises at least 0.01 wt %, optionally from 0.05 to 5 wt %, such as from 0.1 to 5 wt % of a transition metal selected from the group consisting of Cu, Fe, Ti, Zr, Nb, Hf, Ta and combinations thereof. Preferably, this transition metal is primarily extra-framework metal.

In one embodiment the small pore size synthetic zeolite is a silicate or an aluminosilicate having a SiO₂:Al₂O₃ molar ratio of greater than 6:1, preferably greater than 12:1, in particular greater than 30:1, wherein the catalytic metal is selected from the group consisting of Pt, Rh, Pd and Au, and combinations thereof, in particular Pt, Pd and/or Rh, and wherein the zeolite is of framework type CHA, AEI, AFX, RHO, KFI or LTA, in particular CHA or AFX.

In one embodiment the small pore size synthetic zeolite is in as-synthesized form and comprises a structure directing agent (SDA), in particular an organic structure directing agent (OSDA), within its pores.

In an alternative embodiment the small pore size synthetic zeolite does not comprise a structure directing agent. For example, the small pore size synthetic zeolite may be in calcined form.

The inventors have found that by careful design of the synthesis method it is possible to produce the small pore size synthetic zeolites of the invention in which the catalytic metal is to a large extent encapsulated in the zeolite. In one aspect the invention provides a process for the preparation of the small pore synthetic zeolite of the invention comprising:

a) providing a reaction mixture comprising a synthesis mixture capable of forming the small pore size synthetic zeolite framework and at least one catalytic metal precursor, wherein the catalytic metal precursor includes metal complexes stabilized by ligands L selected from the group consisting of N-containing ligands, O-containing ligands, S-containing ligands, and P-containing ligands,

b) heating said reaction mixture under crystallization conditions to form crystals of said small pore size synthetic zeolite, and

c) recovering said crystals of the small pore size synthetic zeolite from the reaction mixture.

In this aspect of the process for the preparation of the small pore size synthetic zeolite the inventors believe, without wishing to be bound by theory, that the ligands L stabilize the metal complex in the synthesis mixture, which is generally highly alkaline, such that it does not become part of the zeolite framework or precipitate from the solution to form large particles which cannot be encapsulated.

The ligand L may be a O-containing ligand, such as oxalate ion or acetylacetonate ion. Alternatively, the ligand L may be a S-containing ligand, such as a thiol of the structure HS—(CH₂)ₓ—Si—(OR)₃, where x=1 to 5 and R=C₁ to C₄ alkyl, preferably methyl, ethyl, propyl, or butyl, most preferably x=3 and R=methyl or ethyl, or the S-containing ligand may be an alkyl thiol. Alternatively, the ligand L may be a P-containing ligand, such as phosphine, for example, triphenylphosphine. Preferably, the ligand L is a N-containing ligand, in particular an amine such as NH₃, ethylenediamine, diethylenetriamine, triethylenetetramine or tetraethylene pentamine, preferably selected from the group consisting of NH₃ and bidentate amines such as ethylene diamine and combinations thereof. The ligand L should be chosen such that the catalytic metal precursor is stable in the highly alkaline conditions of the synthesis mixture, or in a fluoride media. In particular, the catalytic metal precursor should be stable against precipitation at the pH of the synthesis mixture under the conditions used to form the small pore synthetic zeolite.

Optionally, the catalytic metal precursor is selected from the group consisting of [Pt(NH₃)₄]Cl₂, [Pt(NH₃)₄](NO₃)₂, [Pd(NH₂CH₂CH₂NH₂)₂]Cl₂, [Rh(NH₂CH₂CH₂NH₂)₃]Cl₃, [Ir(NH₃)₅Cl]Cl₂, [Re(NH₂CH₂CH₂NH₂)₂O₂]Cl, [Ag(NH₂CH₂CH₂NH₂)]NO₃, [Ru(NH₃)₆]Cl₃, [Ir(NH₃)₆]Cl₃, [Ir(NH₃)₆](NO₃)₃, [Ir(NH₃)₅NO₃](NO₃)₂.

Advantageously, the synthesis mixture capable of forming the small pore size synthetic zeolite framework comprises a source of a tetravalent element X and/or a source of a trivalent element Y, and optionally a source of a pentavalent element Z, and the molar ratio of the catalytic metal precursor (in terms of metal):(XO₂+Y₂O₃+Z₂O₅) in the synthesis mixture is in the range of from 0.00001 to 0.015, preferably from 0.0001 to 0.010, more preferably from 0.001 to 0.008. In a preferred embodiment, the synthesis mixture capable of forming the small pore size synthetic zeolite framework comprises a source of a tetravalent element X and optionally a source of a trivalent element Y, and the molar ratio of the catalytic metal precursor (in terms of metal):(XO₂+Y₂O₃) in the synthesis mixture is in the range of from 0.00001 to 0.015, preferably from 0.0001 to 0.010, more preferably from 0.001 to 0.008.

In an alternative method the invention provides a process for the preparation of the small pore size synthetic zeolite of the invention comprising the steps of

a) providing a reaction mixture comprising a synthesis mixture capable of forming the small pore size synthetic zeolite framework, at least one anchoring agent, and at least one catalytic metal precursor, wherein the anchoring agent includes at least one amine and/or thiol group and at least one alkoxysilane group and the catalytic metal precursor includes at least one ligand capable of being exchanged by the at least one amine group and/or thiol group of the anchoring agent,

b) heating said reaction mixture under crystallization conditions to form crystals of said small pore size synthetic zeolite; and

c) recovering said crystals of the small pore size synthetic zeolite from the reaction mixture.

In this approach, the inventors believe, without wishing to be bound by theory, that the anchoring agent reacts with the catalytic metal precursor and also with the framework of the zeolite to anchor the catalytic metal precursor in the zeolite as the framework forms.

Optionally, the anchoring agent is a thiol of the structure HS—(CH₂)ₓ—Si—(OR)₃, where x=1 to 5 and R=C₁ to C₄ alkyl, preferably methyl, ethyl, propyl, or butyl, most preferably x=3 and R=methyl or ethyl. In an alternative embodiment the anchoring agent is an amine of the structure H₂N—(CH₂)ₓ—Si—(OR)₃, where x=1 to 5 and R=C₁ to C₄ alkyl, preferably methyl, ethyl, propyl, or butyl, most preferably x=3 and R=methyl or ethyl. Advantageously, the synthesis mixture capable of forming the small pore size synthetic zeolite framework comprises a source of a tetravalent element X and/or a source of a trivalent element Y, and optionally a source of a pentavalent element Z, and the molar ratio of anchoring agent:(XO₂+Y₂O₃+Z₂O₅) is in the range of from 0.001 to 0.020, preferably in the range of from 0.002 to 0.015. In a preferred embodiment, the synthesis mixture capable of forming the small pore size synthetic zeolite framework comprises a source of a tetravalent element X and optionally a source of a trivalent element Y, and the molar ratio of anchoring agent:(XO₂+Y₂O₃) is in the range of from 0.001 to 0.020, preferably in the range of from 0.002 to 0.015.

Optionally, the molar ratio of catalytic metal precursor (in terms of metal):(XO₂+Y₂O₃+Z₂O₅) or more particularly the molar ratio of catalytic metal precursor (in terms of metal):(XO₂+Y₂O₃) is in the range of from 0.0001 to 0.001, preferably from 0.0002 to less than 0.001, more preferably from 0.0002 to 0.0005. The catalytic metal precursor can be any suitable catalytic metal complex which includes at least one ligand capable of being exchanged by the at least one amine group and/or thiol group of the anchoring agent. Optionally, the catalytic metal precursor is selected from the group consisting of H₂PtCl₆, H₂PtBr₆, Pt(NH₃)₄Cl₂, Pt(NH₃)₄(NO₃)₂, RuCl₃.xH₂O, RuBr₃.xH₂O, RhCl₃.xH₂O, Rh(NO₃)_{3.2}H₂O, RhBr₃.xH₂O, PdCl₂.xH₂O, Pd(NH₃)₄Cl₂, Pd(NH₃)₄B₄₂, Pd(NH₃)(NO₃)₂, AuCl₃, HAuBr₄.xH₂O, HAuCl₄, HAu(NO₃)₄.xH₂O, Ag(NO₃)₂, ReCl₃, Re₂O₇, OsCl₃, OsO₄, IrBr₃.4H₂O, IrCl₂, IrCl₄, IrCl₃.xH₂O, and IrBr₄, where x is from 1 to 18, preferably from 1 to 6.

In one embodiment the synthesis mixture capable of forming the small pore size synthetic zeolite framework comprises a source of a tetravalent element X and/or a source of a trivalent element Y, optionally a source of a pentavalent element Z, optionally a source of a divalent element W, optionally a source of an alkali metal M, a source of hydroxide ions and/or a source of halide ions, a source of a structure directing agent (SDA) (in particular a source of an organic structure directing agent (OSDA)), and water. In a preferred embodiment, the synthesis mixture capable of forming the small pore size synthetic zeolite framework comprises a source of a tetravalent element X, optionally a source of a trivalent element Y, optionally a source of an alkali metal M, a source of hydroxide ions and/or a source of halide ions, a source of a structure directing agent (SDA) (in particular a source of an organic structure directing agent (OSDA)), and water.

The tetravalent element X is most often one or more of Si, Ge, Sn and Ti, preferably Si or a mixture of Si and Ti or Ge, most preferably Si. Where X═Si, suitable sources of silicon (Si) that can be used to prepare the synthesis mixture include silica; colloidal suspensions of silica, for example that sold by E.I. du Pont de Nemours under the tradename Ludox®; precipitated silica; alkali metal silicates such as potassium silicate and sodium silicate; tetraalkyl orthosilicates; and fumed silicas such as Aerosil and Cabosil.

The trivalent element Y is most often one or more of B, Al, Fe, and Ga, preferably B, Al or a mixture of B and Al, most preferably Al.

Suitable sources of trivalent element Y that can be used to prepare the synthesis mixture depend on the element Y that is selected (e.g., boron, aluminum, iron and gallium). In embodiments where Y is boron, sources of boron include boric acid, sodium tetraborate and potassium tetraborate. Sources of boron tend to be more soluble than sources of aluminum in hydroxide-mediated synthesis systems. Optionally, the trivalent element Y is aluminum, and the aluminum source includes aluminum sulfate, aluminum nitrate, aluminum hydroxide, hydrated alumina, such as boehmite, gibbsite, and pseudoboehmite, and mixtures thereof. Other aluminum sources include, but are not limited to, other water-soluble aluminum salts, sodium aluminate, aluminum alkoxides, such as aluminum isopropoxide, or aluminum metal, such as aluminum in the form of chips.

Alternatively or in addition to previously mentioned sources of Si and Al, sources containing both Si and Al elements can also be used as sources of Si and Al. Examples of suitable sources containing both Si and Al elements include amorphous silica-alumina gels, kaolin, metal-kaolin, and zeolites, in particular aluminosilicates such as synthetic faujasite and ultrastable faujasite, for instance USY.

Suitable sources of pentavalent elements Z depend on the element Z that is selected. Preferably, Z is phosphorus. Suitable sources of phosphorus include one or more sources selected from the group consisting of phosphoric acid; organic phosphates, such as triethyl phosphate, tetraethyl-ammonium phosphate; aluminophosphates; and mixtures thereof. Optionally, the synthesis mixture also contains a source of a divalent element W. Optionally, W is selected from the group consisting of Be and Zn.

Optionally, the synthesis mixture also contains a source of halide ions, which may be selected from the group consisting of chloride, bromide, iodide or fluoride, preferably fluoride. The source of halide ions may be any compound capable of releasing halide ions in the molecular sieve synthesis mixture. Non-limiting examples of sources of halide ions include hydrogen fluoride; salts containing one or several halide ions, such as metal halides, preferably where the metal is sodium, potassium, calcium, magnesium, strontium or barium; ammonium fluoride; or tetraalkylammonium fluorides such as tetramethylammonium fluoride or tetraethylammonium fluoride. If the halide ion is fluoride, a convenient source of halide ion is HF or NH₄F.

Optionally, the synthesis mixture also contains a source of alkali metal M⁺. If present, the alkali metal M⁺ is preferably selected from the group consisting of sodium, potassium and mixtures of sodium and potassium. The sodium source may be a sodium salt such as NaCl, NaBr, or NaNO₃; sodium hydroxide or sodium aluminate. The potassium source may be potassium hydroxide or potassium halide such as KCl or NaBr or potassium nitrate.

Optionally, the synthesis mixture also contains a source of hydroxide ions, for example, an alkali metal hydroxide such as sodium hydroxide or potassium hydroxide. Hydroxide can also be present as a counter ion of the (organic) structure directing agent or by the use of sodium aluminate or potassium aluminate as a source of Y, or by the use of sodium silicate or potassium silicate as the source of X. Sodium or potassium aluminate and silicate can also be used as the source of alkali metal M⁺.

The synthesis mixture optionally further comprises a structure directing agent (SDA), in particular an organic structure directing agent (OSDA). The nature of the SDA (or OSDA) will depend upon the desired framework type. Many such structure directing agents are known to the skilled person. The structure directing agent may be present in any suitable form, for example as a salt of a halide such as a chloride, iodide or bromide, as a hydroxide or as a nitrate. The structure directing agent will generally be cationic and preferably be an organic structure directing agent, for example, a nitrogen-containing cation such as a quaternary ammonium cation. For example, the OSDA may optionally be N,N,N-trimethyl-1-adamantammonium hydroxide or iodide (TMAdA) where it is desired to produce a zeolite of framework type CHA or 1,1′-(hexane-1,6-diyl)bis(1-methylpiperidinium) where it is desired to produce a zeolite of framework type AFX.

The synthesis mixture can have any composition which is suitable for preparing the desired zeolite framework. The following ranges are given as examples of desirable and preferred ranges for each pair of components in the synthesis mixture. Conveniently, the molar ratio of XO₂:Y₂O₃ in the synthesis mixture may be in the range of from 1 to infinity (i.e. no Y), in particular from 1 to 100, preferably from 4 to 50. Optionally, in the synthesis mixture the molar ratio of SDA:(XO₂+Y₂O₃+Z₂O₅) is in the range of from 0.04 to 0.5, preferably from 0.08 to 0.3. Optionally, in the synthesis mixture the molar ratio of H₂O:(XO₂+Y₂O₃) is in the range of from 1 to 100, preferably from 10 to 60. Optionally, in the synthesis mixture the molar ratio of M⁺:(XO₂+Y₂O+Z₂O₅) is in the range of from 0 to 0.45, preferably from 0 to 0.20. Optionally, in the synthesis mixture the molar ratio of OH⁻:(XO₂+Y₂O₃+Z₂O₅) is in the range of from 0 to 1.0, preferably from 0.2 to 0.4. Optionally, in the synthesis mixture the molar ratio of halide⁻:(XO₂+Y₂O₃+Z₂O₅) is in the range of from 0 to 1, preferably from 0 to 0.5. In a preferred embodiment, no Z is present and the molar ratio of XO₂:Y₂O₃ in the synthesis mixture may be in the range of from 1 to infinity (i.e. no Y when the zeolite is a silicate), in particular from 1 to 100, preferably from 4 to 50, e.g. when the zeolite is an aluminosilicate or a borosilicate; the molar ratio of SDA:(XO₂+Y₂O₃) is in the range of from 0.04 to 0.5, preferably from 0.08 to 0.3; the molar ratio of H₂O:(XO₂+Y₂O₃) is in the range of from 1 to 100, preferably from 10 to 60; the molar ratio of M⁺:(XO₂+Y₂O₃) is in the range of from 0 to 0.45, preferably from 0 to 0.20; the molar ratio of OH⁻:(XO₂+Y₂O₃) is in the range of from 0 to 1.0, preferably from 0.2 to 0.4; and the molar ratio of halide⁻:(XO₂+Y₂O₃) is in the range of from 0 to 1, preferably from 0 to 0.5. The reaction mixture may for example have a composition, expressed in terms of mole ratios, as indicated in the following Table:

| Mole ratio | Useful | Preferred |
|---|---|---|
| XO₂/Y₂O₃ | 1 to 100 | 4 to 50 |
| | (or ∞ if no Y) | (or ∞ if no Y) |
| SDA/(XO₂ + Y₂O₃) | 0.04 to 0.5 | 0.08 to 0.3 |
| H₂O/(XO₂ + Y₂O₃) | 1 to 100 | 5 to 60 |
| M⁺/(XO₂ + Y₂O₃) | 0 to 0.45 | 0 to 0.20 |
| OH⁻/(XO₂ + Y₂O₃) | 0 to 1.0 | 0.2 to 0.4 |
| Halide⁻/(XO₂ + Y₂O₃) | 0 to 1 | 0 to 0.5 |

The synthesis may be performed with or without added nucleating seeds. If nucleating seeds are added to the synthesis mixture, the seeds are suitably present in an amount from about 0.01 ppm by weight to about 10,000 ppm by weight, based on the synthesis mixture, such as from about 100 ppm by weight to about 5,000 ppm by weight of the synthesis mixture. The seeds can for instance be of any suitable zeolite, in particular of a zeolite having the same framework as the zeolite to be obtained.

Crystallization can be carried out under either static or stirred conditions in a suitable reactor vessel, such as for example, polypropylene jars or Teflon® lined or stainless steel autoclaves. The crystallization is typically carried out at a temperature of about 100° C. to about 200° C., such as about 150° C. to about 170° C., for a time sufficient for crystallization to occur at the temperature used, e.g., from about 1 day to about 100 days, in particular from 1 to 50 days, for example from about 2 days to about 40 days. Thereafter, the synthesized crystals are separated from the mother liquor and recovered.

Since the as-synthesized crystalline zeolite contains the structure directing agent within its pore structure, the product is typically activated before use in such a manner that the organic part of the structure directing agent is at least partially removed from the zeolite. The activation process is typically accomplished by calcining, more particularly by heating the zeolite at a temperature of at least about 200° C., preferably at least about 300° C., more preferably at least about 370° C. for at least 1 minute and generally not longer than 20 hours. While subatmospheric pressure can be employed for the thermal treatment, atmospheric pressure is usually desired for reasons of convenience. The thermal treatment can be performed at a temperature up to about 925° C. For instance, the thermal treatment can be conducted at a temperature of from 400 to 600° C., for instance from 500 to 550° C., in the presence of an oxygen-containing gas, for example in air.

The small pore size synthetic zeolite of the present invention or manufactured by the process of the present invention may be used as an adsorbent or as a catalyst to catalyze a wide variety of organic compound conversion processes including many of present commercial/industrial importance. Examples of preferred chemical conversion processes which can be effectively catalyzed by the zeolite of the present invention or manufactured by the process of the present invention, by itself or in combination with one or more other catalytically active substances including other crystalline catalysts, include those requiring a catalyst with acid activity or hydrogenation activity. Examples of organic conversion processes which may be catalyzed by zeolite of the present invention or manufactured by the process of the present invention include cracking, hydrocracking, isomerization, polymerization, reforming, hydrogenation, dehydrogenation, dewaxing, hydrodewaxing, adsorption, alkylation, transalkylation, dealkylation, hydrodecylization, disproportionation, oligomerization, dehydrocyclization and combinations thereof. The conversion of hydrocarbon feeds can take place in any convenient mode, for example in fluidized bed, moving bed, or fixed bed reactors depending on the types of process desired.

The zeolite of the present disclosure, when employed either as an adsorbent or as a catalyst in an organic compound conversion process should be dehydrated, at least partially. This can be done by heating to a temperature in the range of about 100° C. to about 500° C., such as about 200° C. to about 370° C. in an atmosphere such as air, nitrogen, etc., and at atmospheric, subatmospheric or superatmospheric pressures for between 30 minutes and 48 hours. Dehydration can also be performed at room temperature merely by placing the molecular sieve in a vacuum, but a longer time is required to obtain a sufficient amount of dehydration.

Once the zeolite has been synthesized, it can be formulated into a catalyst composition by combination with other materials, such as binders and/or matrix materials that provide additional hardness or catalytic activity to the finished catalyst. These other materials can be inert or catalytically active materials.

In particular, it may be desirable to incorporate the zeolite of the present invention or manufactured by the process of the present invention with another material that is resistant to the temperatures and other conditions employed in organic conversion processes. Such materials include active and inactive materials and synthetic or naturally occurring zeolites as well as inorganic materials such as clays, silica and/or metal oxides such as alumina. The latter may be either naturally occurring or in the form of gelatinous precipitates or gels including mixtures of silica and metal oxides. Naturally occurring clays which may be used include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or after being subjected to calcination, acid treatment or chemical modification. These binder materials are resistant to the temperatures and other conditions, e.g., mechanical attrition, which occur in various hydrocarbon conversion processes. Thus the zeolites of the present invention or manufactured by the process of the present invention may be used in the form of an extrudate with a binder. They are typically bound by forming a pill, sphere, or extrudate. The extrudate is usually formed by extruding the zeolite, optionally in the presence of a binder, and drying and calcining the resulting extrudate.

Use of a material in conjunction with the zeolite of the present invention or manufactured by the process of the present invention, i.e., combined therewith or present during synthesis of the new crystal, which is active, tends to change the conversion and/or selectivity of the catalyst in certain organic conversion processes. Inactive materials suitably serve as diluents to control the amount of conversion in a given process so that products can be obtained in an economic and orderly manner without employing other means for controlling to the rate of reaction. These materials may be incorporated into naturally occurring clays, e.g., bentonite and kaolin, to improve the crush strength of the catalyst under commercial operating conditions.

In addition to the foregoing materials, the zeolite can be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

The relative proportions of zeolite and inorganic oxide matrix may vary widely, with the molecular sieve content ranging from about 1 to about 90 percent by weight and more usually, particularly when the composite is prepared in the form of beads, in the range of about 2 to about 80 weight percent of the composite.

### EXAMPLES

The following examples illustrate the present invention. Numerous modifications and variations are possible and it is to be understood that within the scope of the appended claims, the invention may be practiced otherwise than as specifically described herein.

In the following examples, various parameters were measured in order to define the properties of the products that were manufactured. A suitable XRD method involved a Bruker D4 diffractometer using Cu Kα radiation at 35 kV/45 mA, 0.20° divergence slit, and a Vantec detector. Data was collected from 2 to 50° 2-theta, 0.018° step size, and 0.2 sec/step counting time using Bragg-Brentano geometry.

For every zeolite prepared according to the present invention the degree of crystallinity was >95%. The absence of any amorphous material was determined by the absence of a broad diffraction peak in the 2-theta range of 18-25° and by the absence of a second amorphous phase in the SEM pictures.

### Example 1: Pt Encapsulated in High Silica CHA Zeolite Using TMSH as Anchoring Agent [Pt:(SiO₂+Al₂O₃)=0.00032]

This example illustrates successful preparation of a sintering-resistant platinum catalyst according to the present invention.

800 mg of sodium hydroxide (99 wt %, Sigma-Aldrich) was dissolved in 6.9 g of water. Then, 86 mg of a 8 wt % aqueous solution of chloroplatinic acid (H₂PtCl₆, 37.50 wt % Pt basis, Sigma-Aldrich) and 52 mg of (3-mercaptopropyl)trimethoxysilane (TMSH, 95%, Sigma-Aldrich) were added to the above solution, and the mixture was stirred for 30 minutes. Afterwards, 13.04 g of an aqueous solution of N,N,N-trimethyl-1-adamantammonium hydroxide (TMAdA, 16.2 wt %) was added and maintained under stirring during 15 minutes. At that time, 293 mg of aluminum hydroxide (58 wt %, Sigma-Aldrich) was added, and the resultant mixture kept under stirring at 80° C. for 30 minutes. Finally, 3 g of colloidal silica (Ludox AS40, 40 wt %, Aldrich) was introduced in the synthesis mixture, and maintained under stirring at 80° C. for 30 minutes. The final gel composition was SiO₂:0.033 Al₂O₃:0.00033 Pt:0.005 TMSH:0.2 TMAdA:0.4 NaOH:20 H₂O.

The gel was transferred to an autoclave with a Teflon liner, and heated at 90° C. for 7 days, and later, at 160° C. for 2 days under dynamic conditions. The sample after the hydrothermal crystallization was filtered and washed with abundant distilled water, and finally dried at 100° C.

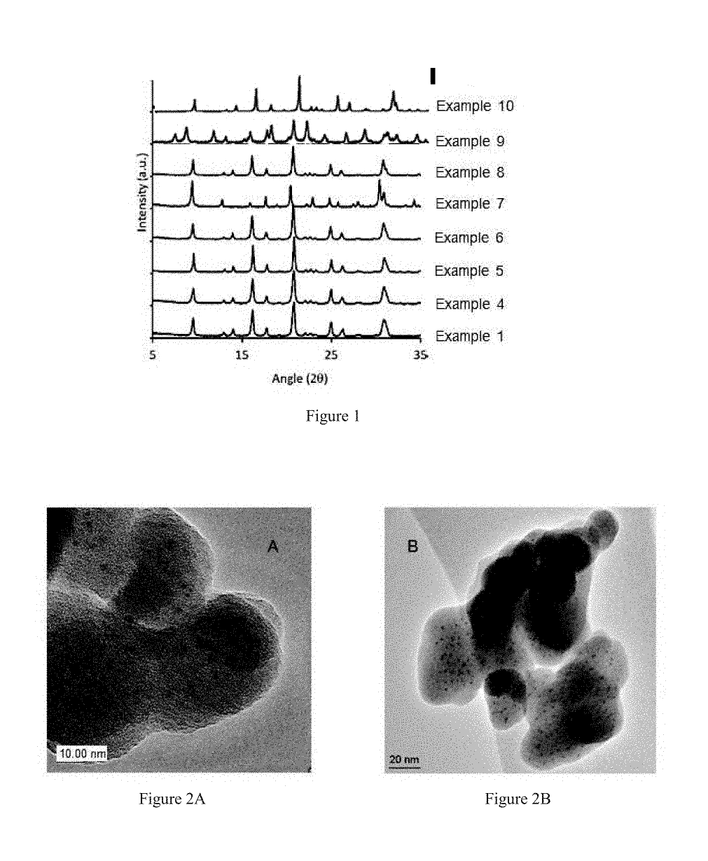

The solid was characterized by Powder X-ray Diffraction (PXRD), obtaining the characteristic PXRD pattern of the CHA material (see Example 1 in FIG. 1). Elemental analysis by ICE-AES of the resultant solid indicated a Si/Al of 8.5 (SiO₂:Al₂O₃ molar ratio of 17:1) and analysis by XRF gave a Pt content of 0.21 wt %.

The Pt-containing CHA was calcined at 550° C. in air in order to remove the organic moieties included inside the microporous material during the crystallization process.

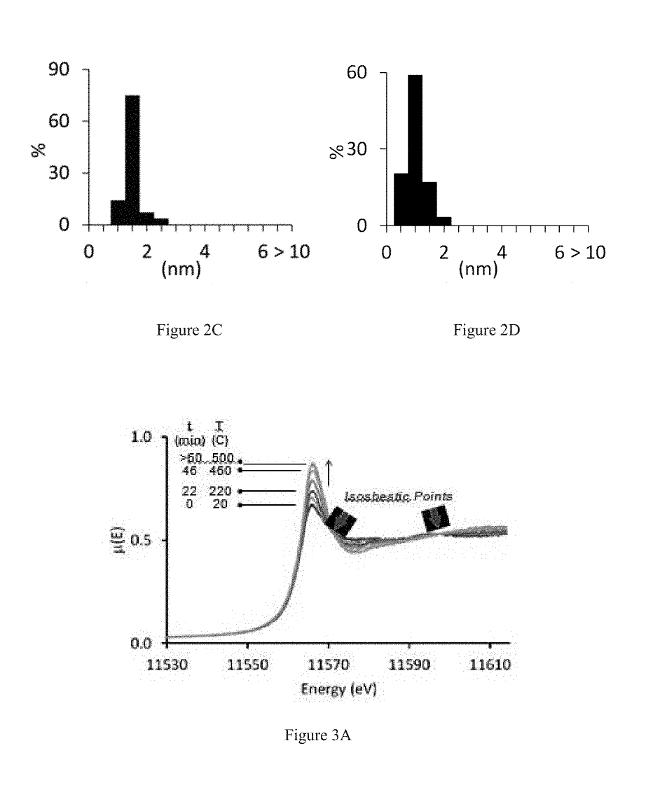

The calcined sample was treated with H₂ at 400° C. for 2 hours. TEM microscopy (see FIG. 2A) reveals the formation of very small Pt nanoparticles. These Pt nanoparticles are substantially spherical and have a particle size (biggest dimension, i.e. diameter) in the range of 1 to 3 nm within the high-silica CHA structure. The particle size distribution (diameter vs. abundance expressed as a percentage of the particles by number) for this sample is shown in FIG. 2C.

The above reduced sample was subjected to an additional thermal treatment. It was oxidized in air at 650° C. for 2 hours (50 sccm of pure O₂ at atmospheric pressure to treat 200 mg of catalyst), followed by a 1 hour purge with N₂ (50 sccm of pure N₂ at atmospheric pressure to treat 200 mg of catalyst) and later, reduced again with H₂ at 400° C. for 2 hours (50 sccm of pure H₂ at atmospheric pressure to treat 200 mg of catalyst). TEM microscopy (see FIG. 2B) reveals that the small Pt nanoparticles within the high-silica CHA structure remain stable and have not sintered into larger particles after the additional thermal (or redox) treatments. The particle size distribution (diameter vs. abundance expressed as a percentage of the particles by number) for this sample after the additional thermal treatment is shown in FIG. 2D.

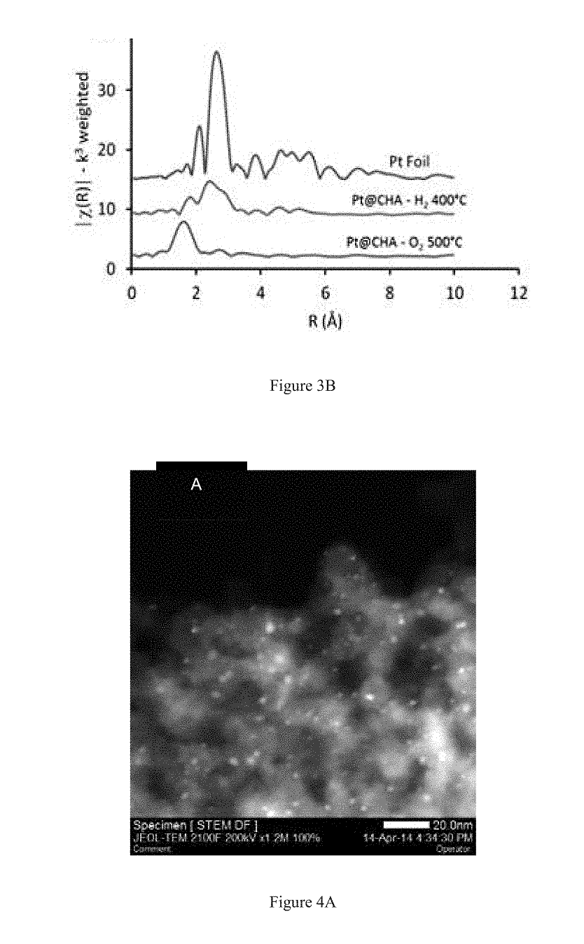

In order to examine the formation of oxidized platinum structures during the O₂ treatment step X-Ray Absorption Near Edge Structure (XANES) was recorded as the sample, previously reduced with H₂ at 400° C., was treated with 5% O₂ at increasing temperatures (from 20 to 500° C.). The spectra show a gradual decrease of the first absorption peak (white line intensity), which is ascribed to gradual oxidation of the metal nanoparticles (FIG. 3A). The observation of isosbestic point in the spectra indicate simple stoichiometric transformation of one species into another, consistent with a fine control of the catalytic structures and their uniformity. Extended X-Ray Fine Structure (EXAFS) after completion of the oxidation treatment shows the absence of any signal attributed to Pt backscatterers, which demonstrates the lack of Pt—Pt or Pt—O—Pt moieties; EXAFS clearly evidences the presence of oxygen bonded to these single-site platinum centers (FIG. 3B—bottom line). For comparison. FIG. 3B also shows the EXAFS spectrum of a platinum foil (upper line), and that corresponding to the sample of Example 1 (calcined at 550° C., and treated with H₂ at 400° C.) (middle line in FIG. 3B—note that the Pt—Pt peak intensity in the sample is small compared to the reference foil, an additional proof of the smallness of the nanoparticles).

### Example 2: Pt-Containing Amorphous SiO₂— Comparative

A catalyst consisting of platinum nanoparticles supported on amorphous silica (reference material) was prepared according to the process of WO2011/096999. In this procedure, 1.784 g of tetraamine platinum hydroxide was mixed with 12.2 g of deionized water, 0.6 g of arginine was added to this solution so that the arginine to Pt molar ratio was 8:1. The solution was added by incipient wetness onto 10.0 g of Davison silica (grade 62, 60-200 mesh, 150 Angstrom pore diameter from Sigma-Aldrich). The sample was dried at 120° C. for 2 hrs. The dried sample was placed in a tube furnace with an active air flow of 300 sccm of air, with the heating rates being maintained at 3° C./min to 400° C., and then maintaining the temperature at 400° C. for 16 hrs. The chemical analysis of the resultant solid by ICE-AES indicated a Pt content of 0.8% wt.

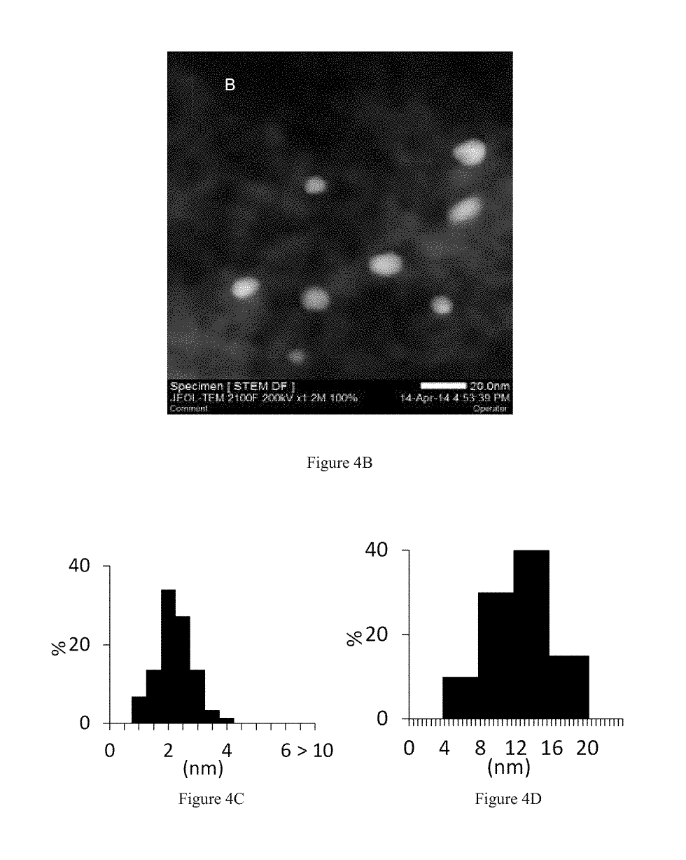

The calcined sample was treated with H₂ at 400° C. for 2 hours. TEM microscopy (see FIG. 4A) reveals the formation of small Pt nanoparticles on the silica surface. The particle size distribution (diameter vs. abundance expressed as a percentage of the particles by number) for this sample is shown in FIG. 4C.

The above reduced sample was subjected to an additional thermal treatment. It was oxidized in air at 650° C. for 2 hours (50 sccm of pure O₂ at atmospheric pressure to treat 200 mg of catalyst), followed by a 1 hour purge with N₂ (50 sccm of pure N₂ at atmospheric pressure to treat 200 mg of catalyst) and later, reduced again with H₂ at 400° C. for 2 hours (50 sccm of pure H₂ at atmospheric pressure to treat 200 mg of catalyst). TEM microscopy (see FIG. 4B) reveals that the small Pt nanoparticles suffer from severe sintering as a result of the additional thermal (or redox) treatment. The particle size distribution (diameter vs. abundance expressed as a percentage of the particles by number) for this sample after the additional thermal treatment is shown in FIG. 4D.

### Example 3: Shape Selective Hydrogenation Catalysis

In a typical experiment, 40 mg of the catalyst synthesized according to Examples 1 and 2 (after calcination and reduction but after the additional thermal treatment) were mixed with 1 g of neutral silica (silica gel, Davisil Grade 640, 35-60 mesh) and loaded in a conventional tubular plug-flow reactor (ID=6/16 inches 9.53 mm). High purity hydrogen, ethylene (or propylene), and nitrogen were fed through the catalyst bed at atmospheric pressure and flow rates were regulated by standard mass flow controllers. The temperature of the catalyst bed was controlled using a three-zone vertical furnace (ATS, model 3210) with a precision of ±1° C.

The downstream reaction effluents were analyzed in a gas chromatograph (Agilent 5975B) connected in series, and equipped with a 50 m capillary column (Rt-Alumina BOND/Na₂SO₄, 0.53 mm ID, 10 μm) and a FID detector. The conditions of the analysis were: initial oven temperature=50° C.; temperature ramp=10° C./min; final oven temperature=180° C.; injector temperature=220° C.; detector temperature=320° C.; pressure at the head of the column=9.7 psi. For identification purposes, the position of the various reactants and products within the gas chromatogram were compared with standards commercially available. Conversions and selectivity were calculated from the corresponding GC areas. Typically, the reactor was operated in the differential conversion range (<15%) allowing determination of the reaction rates directly from the GC data.

Prior to the hydrogenation experiment, the catalyst was reduced in situ in a flow of hydrogen (50 mL/min) at 400° C. for 4 h. The reactor was then cooled down to the selected reaction temperature (80° C.). With the catalyst bed at 80±1° C., a mixture of ethylene (or propylene) (4 mL/min), hydrogen (20 mL/min), and nitrogen (100 mL/min) was flowed through the reactor, and the reacted gas mixture was analyzed at various times on stream.

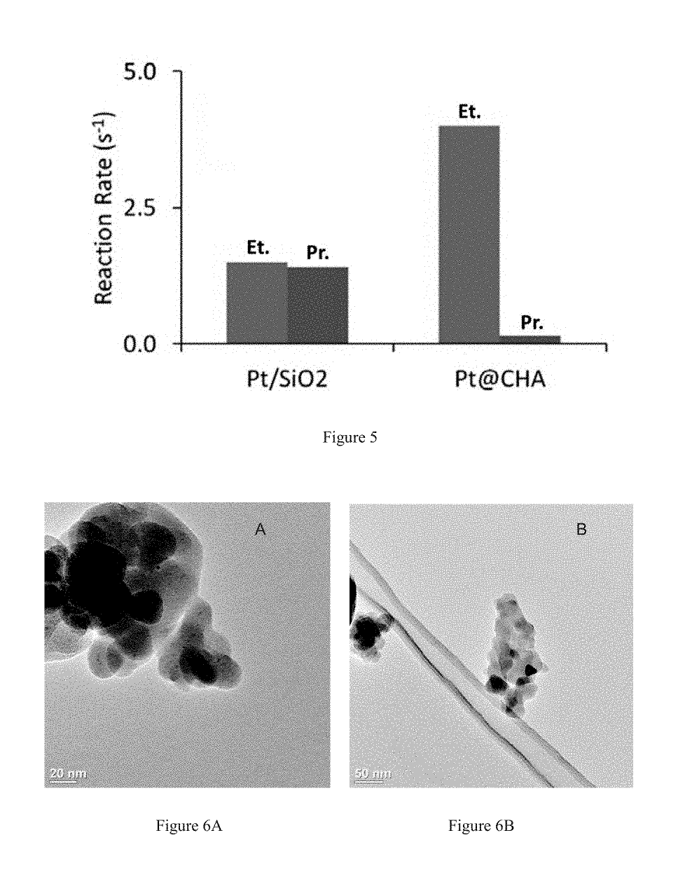

FIG. 5 shows the catalytic activity of the fresh CHA-encapsulated platinum (Example 1) and the Pt/SiO₂ (Example 2) catalysts for each alkene, expressed as mol of reactant converted per mol of platinum per second. On the encapsulated material, the ethylene hydrogenation rate is at least 16 times greater than that of propylene

$$[ \frac{PR zeolite}{ER zeolite} = 16 ] ,$$

whereas both alkenes react at similar rates on the Pt/SiO₂ catalyst

$$[ \frac{PR SiO 2}{ER SiO 2} = 1 ] .$$

This corresponds to a percentage of Pt encapsulated in the zeolite (a) of example 1 of at least 94%. These results further demonstrate successful encapsulation of the metal inside the CHA crystals, where propylene experiences severe diffusional limitations at the selected reaction temperature.

### Example 4: Pt Encapsulated on High Silica CHA Zeolite Using TMSH Anchoring Agent [Pt:(SiO₂+Al₂O₃)=0.00097]

800 mg of sodium hydroxide (99 wt %, Sigma-Aldrich) was dissolved in 6.9 g of water. Then, 256 mg of a 8 wt % aqueous solution of chloroplatinic acid (H₂PtCl₆, 37.50 wt % Pt basis, Sigma-Aldrich) and 52 mg of (3-mercaptopropyl)trimethoxysilane (TMSH, 95 wt %, Sigma-Aldrich) were added to the above solution, and the mixture stirred for 30 minutes. Afterwards, 13.04 g of an aqueous solution of N,N,N-trimethyl-1-adamantammonium hydroxide (TMAdA, 16.2 wt %) was added and maintained under stirring during 15 minutes. At that time, 293 mg of aluminum hydroxide (58 wt %, Sigma-Aldrich) was added, and the resultant mixture kept under stirring at 80° C. for 30 minutes. Finally, 3 g of colloidal silica (Ludox AS40, 40 wt %, Aldrich) was introduced in the synthesis mixture, and maintained under stirring at 80° C. for 30 minutes. The final gel composition was SiO₂:0.033 Al₂O₃:0.001 Pt:0.005 TMSH:0.2 TMAdA:0.4 NaOH:20 H₂O.

The gel was transferred to an autoclave with a Teflon liner, and heated at 90° C. for 7 days, and later, at 160° C. for 2 days under dynamic conditions. The sample after the hydrothermal crystallization was filtered and washed with abundant distilled water, and finally dried at 100° C.

The solid was characterized by Powder X-ray Diffraction (PXRD), obtaining the characteristic PXRD pattern of the CHA material (see Example 4 in FIG. 1). The chemical analysis of the resultant solid indicated a Si/Al ratio of 8 (SiO₂/Al₂O₃ molar ratio of 16:1) and a Pt content of 0.46 wt %.

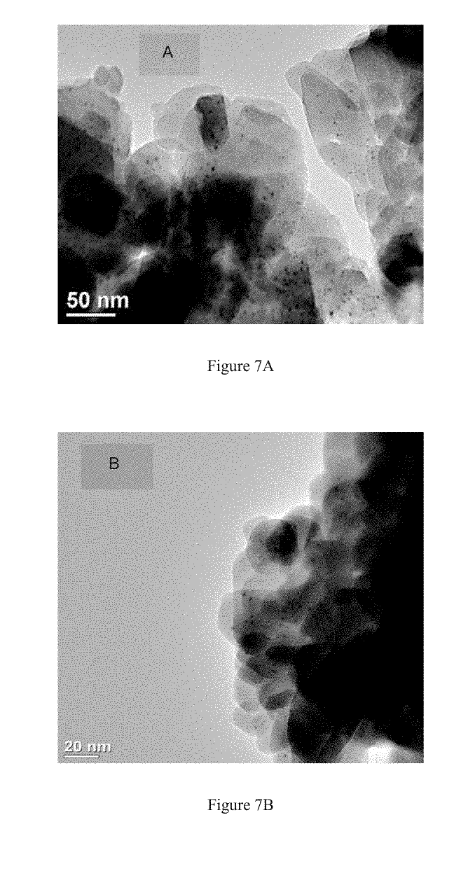

The Pt-containing CHA was calcined at 550° C. in air in order to remove the organic moieties included inside of the microporous material during the crystallization process, and subsequently reduced in flow of H₂ at 400° C. for 2 h. After this two-step thermal treatment, TEM (FIG. 6) reveals the exclusive presence of small metal nanoparticles in approximately 95% of the images (illustrated in FIG. 6A). Approximately 5% of the images include at least one big nanoparticle in addition to the small ones (as illustrated in FIG. 6B). The percentage of Pt encapsulated in the zeolite (a) was determined to be 90%.

### Example 5: Pt Encapsulated in High Silica CHA Zeolite Using Amine Ligands

A synthesis gel was prepared with the composition:

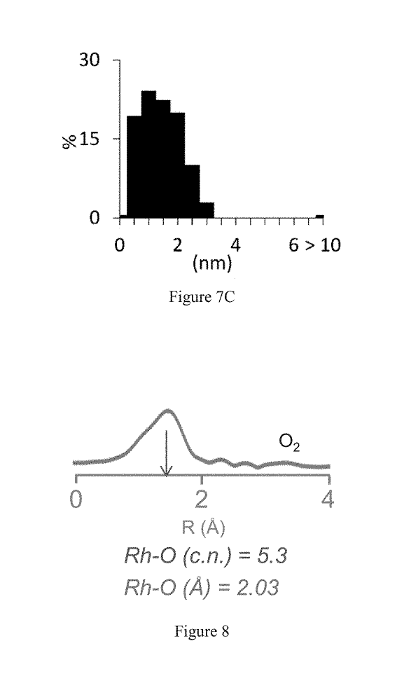

2.15 SDAOH: 0.1 Pt(NH₃)₄(NO₃)₂: 7 Na₂O: Al₂O₃: 25 SiO₂: 715 H₂O, where SDAOH is N,N,N-trimethyl-1-adamantammonium hydroxide. In a 125 ml Teflon-lined autoclave was added 20.82 g of sodium silicate (EMD, 28.2 wt % SiO₂, 9.3 wt % Na₂O), 39.2 g de-ionized water, 0.50 g 50 wt % NaOH and 8.88 g 25 wt % SDAOH. Then 2.80 g of an aqueous solution of Pt(NH₃)₄(NO₃)₂ (3.406 wt % Pt) was added drop wise with vigorous stirring. Next 2.85 g of USY (Engelhard, EZ-190, SiO₂/Al₂O₃=5, 17.5 wt % Al₂O₃) was stirred in. The autoclave was mounted on a rotating shelf (25 rpm) in a 140° C. oven for 7 days. The product was recovered by vacuum filtration, washed with de-ionized water and dried in a 115° C. oven. Phase analysis by powder XRD showed the sample to be pure chabazite (see Example 5 in FIG. 1). The sample was calcined to remove the SDA by heating in a muffle furnace from 25° C. to 400° C. in two hours and 15 min. in nitrogen and then ramping to 600° C. in air and then holding for 2 hours in air. Elemental analysis by ICE-AES gave Si/Al=7.7 (SiO₂:Al₂O₃ molar ratio of 15.4:1) and Na/Al=0.56 and analysis by XRF gave 1.66 wt % Pt. The calcined sample was treated with H₂ at 400° C. for 2 hours. The percentage of Pt encapsulated in the zeolite (a) was determined to be 87%. TEM microscopy (see FIG. 7A) reveals the formation of very small Pt nanoparticles within the high-silica CHA structure. The above reduced sample was subjected to an additional thermal treatment. It was oxidized in air at 650° C. for 2 hours (50 sccm of pure O₂ at atmospheric pressure to treat 200 mg of catalyst), followed by a 1 hour purge with N₂ (50 sccm of pure N₂ at atmospheric pressure to treat 200 mg of catalyst), and later, reduced again with H₂ at 400° C. for 2 hours (50 sccm of pure H₂ at atmospheric pressure to treat 200 mg of catalyst). TEM microscopy (see FIG. 7B) reveals that the small Pt nanoparticles within the high-silica CHA structure remain stable and have not sintered into larger particles after the additional thermal (or redox) treatments. The particle size distribution (diameter vs. abundance expressed as a percentage of the particles by number) for this sample is shown in FIG. 7C.

### Example 6: Rh Encapsulated in High Silica CHA Zeolite Using Amine Ligands

A synthesis gel was prepared with the composition:

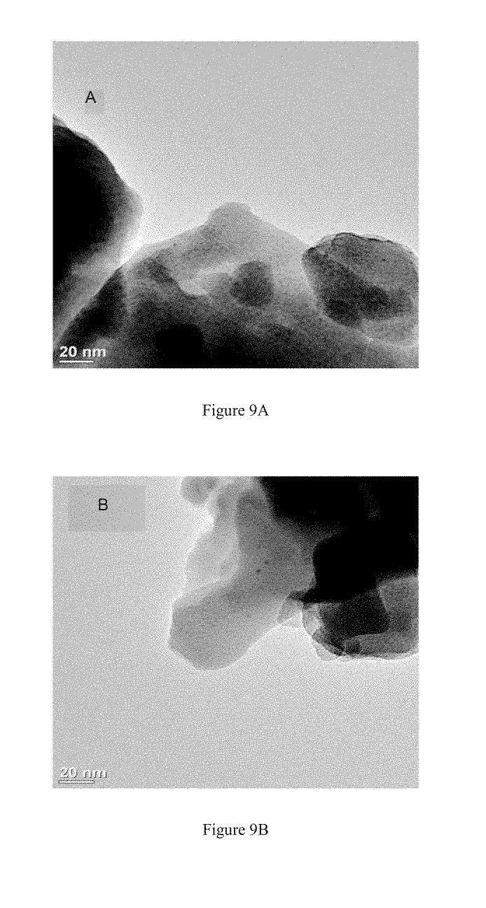

SDAOH: 0.064 Rh(C₂H₄N₂)₃C₃:10 Na₂O:Al₂O₃:34 SiO₂:1000 H₂O, where SDAOH is N,N,N-trimethyl-1-adamantammonium hydroxide (TMAdA). In a 125 ml Teflon-lined autoclave was added 9.49 g 25 wt % SDAOH, 0.46 g 50 wt % NaOH, 23.11 g of sodium silicate (EMD, 28.2 wt % SiO₂, 9.3 wt % Na₂O), and 43.74 g de-ionized water. Then 1.02 g of an aqueous 10 wt % solution of Rh(C₂H₄N₂)₃Cl₃.3H₂O was added drop wise with vigorous stirring. Next 2.18 g of USY (Engelhard, EZ-190, Si/Al=2.5, 17.5 wt % Al₂O₃) was added and stirred for 2 minutes. The autoclave was mounted on a rotating shelf (40 rpm) in an 140° C. oven for 5 days. The product was recovered by vacuum filtration, washed with de-ionized water and dried in a 115° C. oven. Phase analysis by powder XRD showed the sample to be pure chabazite (see Example 6 in FIG. 1). The sample was calcined to remove the SDA by heating in a muffle furnace from 25° C. to 560° C. in two hours in air and then holding for 3 hours in air. Elemental analysis by ICE-AES gave Si/Al=8.5 (SiO₂:Al₂O₃ molar ratio of 17:1) and Na/Al=0.53 and analysis by XRF gave 0.35 wt % Rh. The percentage of Rh encapsulated in the zeolite (a) was determined to be 94%. In order to examine the formation of single atom rhodium species during the O₂ treatment EXAFS spectra were recorded after treatment of the sample, previously reduced with H₂ at 400° C., with 5% O₂ at 500° C. EXAFS spectra after completion of the oxidation treatment shows the absence of any signal attributed to Rh backscatterers, which demonstrates the lack of Rh—Rh or Rh—O—Rh moieties; EXAFS clearly evidences the presence of oxygen bonded to these single-site rhodium centers (FIG. 8).

### Example 7: Rh on CHA Zeolite—Comparative

A mixture of composition:

1.4 K₂O: Al₂O₃: 5.1 SiO₂: 110 H₂O

was prepared by adding 5.8 g of KOH.½H₂O, 14.4 g of silica alumina gel (22.5 wt % Al₂O₃, 67.5 wt % SiO₂) and 59.8 g of water to a 125 ml Teflon lined autoclave. The mixture was placed on a rotating shelf (25 rpm) in a 100° C. oven for 3 days. The product was recovered by vacuum filtration, washed with de-ionized water and dried in a 115° C. oven. Phase analysis by powder XRD showed the sample to be pure chabazite (see Example 7 in FIG. 1). A portion of the chabazite was exchanged twice with 10 wt % NaNO₃ solution, calcined in air for 3 hrs. at 350° C., exchanged a third time, calcined again at 3 hrs. at 350° C., and finally exchanged a fourth time. Elemental analysis by ICE-AES gave Si/Al=2.4 (SiO₂/Al₂O₃ molar ratio of 4.8:1). K/Al=0.18 and Na/Al=0.80. The sodium exchanged chabazite was dried for 60 min at 300° C., and allowed to cool down in a molecular sieve desiccator. Then 0.441 g of an aqueous solution of Rh(NO₃)₃ (10.1 wt % Rh) and 2.27 g of deionized water were placed in 100 ml beaker. The dried chabazite was quickly added and the mixture kneaded by hand for 2 minutes with a ceramic spatula and then mixed for 4 minutes in a dual asymmetric centrifuge (FlackTec DAC600 SpeedMixer). The sample was dried at 115° C., and then ramped to 350° C. at 0.5° C./min in air and then held at 350° C. in air for two hours. The percentage of Rh encapsulated in the zeolite (a) was determined to be 20%.

### Example 8: Rh/Pt Encapsulated in High Silica CHA Zeolite Using Amine Ligands

A 10 g sample of USY (Engelhard, EZ-190, SiO₂/Al₂O₃=5, 17.5 wt % Al₂O₃) was exchanged with 11.7 g of an aqueous solution of Pt(NH₃)₄(NO₃)₂ (3.406 wt % Pt) in 100 mls H₂O. The pH was adjusted to 9 by the addition of dilute NH₄OH, and stirred at 60-80° C. for 4 hours. The product was washed with deionized water and dried in a 115° C. oven. Analysis by XRF gave 4.8 wt % Pt.

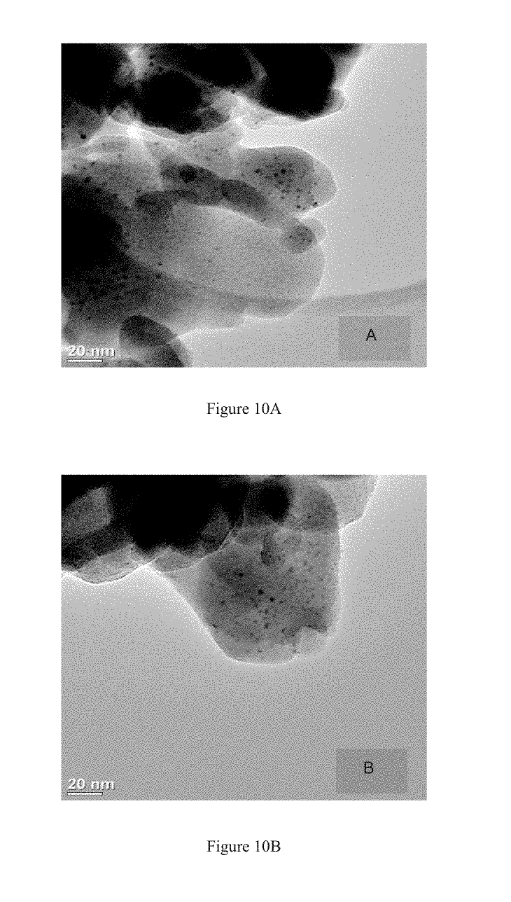

A synthesis gel was then prepared with the composition, 2.2 SDAOH: 0.15 Pt: 0.15 Rh(C₂H₄N₂)₃Cl₃: 7 Na₂O: Al₂O₃: 25 SiO₂: 715 H₂O, where SDAOH is N,N,N-trimethyl-1-adamantammonium hydroxide (TMAdA). In a 125 ml Teflon-lined autoclave was added 9.5 g 25 wt % SDAOH, 1.0 g 50 wt % NaOH, 20.1 g of sodium silicate (EMD, 28.2 wt % SiO₂, 9.3 wt % Na₂O), and 44.6 g de-ionized water. Then 1.7 g of an aqueous 10 wt/o solution of Rh(C₂H₄N₂)₃Cl₃.3H₂O was added drop wise with stirring and then stirred for an additional 10 minutes. Next 1.5 g of USY (Engelhard, EZ-190, Si/Al=2.5, 17.5 wt % Al₂O₃) and 1.6 g of the above Pt exchanged USY was added and stirred until well mixed. The autoclave was mounted on a rotating shelf (25 rpm) in a 140° C. oven for 7 days. The product was recovered by vacuum filtration, washed with de-ionized water and dried in a 115° C. oven. Phase analysis by powder XRD showed the sample to be pure chabazite (see Example 8 in FIG. 1). The sample was calcined to remove the SDA by heating in a muffle furnace from 25° C. to 500° C. in two hours in air and then holding at 500° C. for 3 hours in air. Analysis by XRF gave 0.64 wt % Rh and 1.02 wt % Pt. The calcined sample was treated with H₂ at 400° C. for 2 hours. TEM microscopy (see FIG. 9A) reveals the formation of very small Pt nanoparticles within the high-silica CHA structure. The above reduced sample was oxidized in air at 650° C. for 2 hours, and later, reduced again with H₂ at 400° C. for 2 hours. TEM microscopy (see FIG. 9B) reveals that the small Pt nanoparticles within the high-silica CHA structure remain stable and have not sintered into larger particles after the redox treatments. The percentage of Rh/Pt encapsulated in the zeolite (α) was determined to be 95%.

### Example 9: Rh Encapsulated in AFX Zeolite Using Amine Ligands

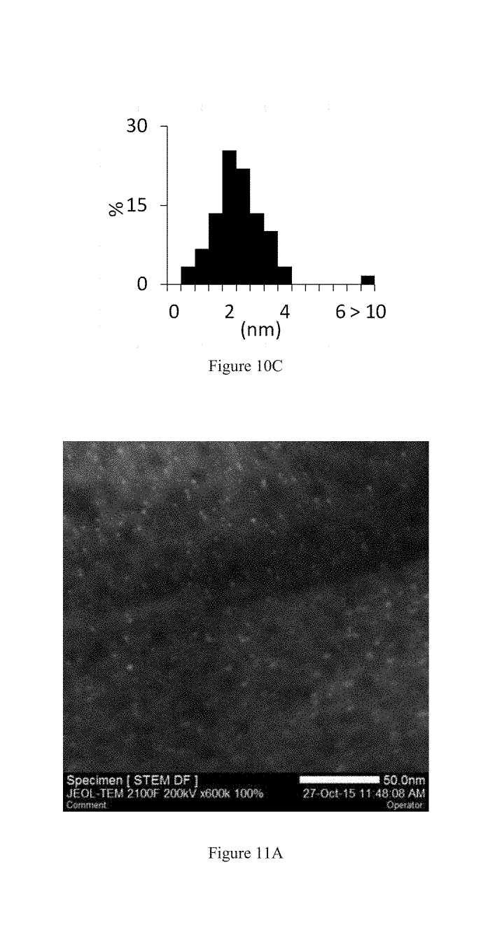

A synthesis gel was prepared with the composition, 12 SDA(OH)₂: 0.25 Rh(C₂H₄N₂)₃Cl₃: 6 Na₂O: Al₂O₃: 40 SiO₂: 1200 H₂O, where SDA is 1,1′-(hexane-1,6-diyl)bis(l-methylpiperidinium). In a plastic beaker was added 28.5 g of colloidal silica (Ludox LS-30), 57.3 g 22.6 wt % SDA(OH)₂, and 6.4 g de-ionized water. Then 3.79 g of an aqueous 10 wt % solution of Rh(C₂H₄N₂)₃Cl₃.3H₂O was added drop wise with stirring and then stirred for an additional 10 minutes. Next 1.45 g of sodium aluminate (USALCO 45, 25 wt % Al₂O₃, 19.3 wt % Na₂O) and 2.7 g of USY (Engelhard, EZ-190, SiO₂/Al₂O₃=5, 17.5 wt % Al₂O₃) was added and stirred with a spatula. The mixture was then thoroughly homogenized in a SS blender and placed in a Teflon-lined autoclave. The autoclave was mounted on a rotating shelf (25 rpm) in a 160° C. oven for 6 days. The product was recovered by vacuum filtration, washed with de-ionized water and dried in a 115° C. oven. Phase analysis by powder XRD showed the sample to be pure AFX zeolite (see Example 9 in FIG. 1). The sample was calcined to remove the SDA by heating in a muffle furnace from 25° C. to 560° C. in two hours in air and then holding for 3 hours in air. Elemental analysis by ICE-AES gave Si/Al=8.5 (SiO₂: Al₂O₃ molar ratio of 17:1) and Na/Al=0.53 and analysis by XRF gave 2.1 wt %1 Rh. The calcined sample was treated with H₂ at 400° C. for 2 hours. The percentage of Rh encapsulated in the zeolite (at) was determined to be 95%. TEM microscopy (see FIG. 10A) reveals the formation of very small Pt nanoparticles within the high-silica AFX structure. The above reduced sample was subjected to an additional thermal treatment. It was oxidized in air at 650° C. for 2 hours (50 sccm of pure O₂ at atmospheric pressure to treat 200 mg of catalyst), followed by a 1 hour purge with N₂ (50 sccm of pure N₂ at atmospheric pressure to treat 200 mg of catalyst), and later, reduced again with H₂ at 400° C. for 2 hours (50 sccm of pure H₂ at atmospheric pressure to treat 200 mg of catalyst). TEM microscopy (see FIG. 10B) reveals that the small Pt nanoparticles within the high-silica CHA structure remain stable and have not sintered into larger particles after the additional (or redox) treatments. The particle size distribution (diameter vs. abundance expressed as a percentage of the particles by number) for this sample is shown in FIG. 10C.

### Example 10: Pt Encapsulated in a Pure SiO₂ CHA Zeolite Using Amine Ligands

1.04 g of a 1 wt % aqueous solution of chloroplatinic acid (H₂PtCl₆.6H₂O, Sigma-Aldrich) was mixed with 4.0 mg of tetraethylenepentamine (TEPA, Sigma-Aldrich), and the mixture was maintained under stirring for 15 minutes. This resulted in the in situ formation of a Pt complex wherein Pt is stabilized by TEPA (N-containing ligands). In a different vessel. 1.28 g of N,N,N-trimethyl-1-adamantammonium iodide (TMAdA) was dissolved in 8 g of a Trizma hydrochloride buffer solution (pH=7.4. Sigma-Aldrich), and the resultant solution mixed with the previous Pt-TEPA solution. Then, 1.0 g of tetraethylorthosilicate (TEOS, Sigma-Aldrich) was added, and the mixture stirred for 15 minutes. At this point, 0.31 g of ethanolamine was added as silica mobilizing agent, to improve the dispersion of the metal complex in the porous SiO₂ matrix, and the mixture stirred at room temperature for 7 days. Finally, the mixture was filtered and washed with abundant distilled water, and dried at 100° C.

23.9 g of an aqueous solution of N,N,N-trimethyl-1-adamantammonium hydroxide (TMAdA, 11.3 wt %) was mixed with 0.6 g of an aqueous solution of hydrofluoric acid (HF, Sigma-Aldrich, 48 wt %), and maintained under stirring during 15 minutes. Then, 3.0 g of the above prepared Pt-containing amorphous silica material and 240 mg of crystals of CHA as seeds were introduced in the synthesis mixture, and maintained under stirring the required time to evaporate the excess of water until achieving the desired gel concentration. The final gel composition was SiO₂:0.3 TMAdA:0.3 HF:3 H₂O.

The gel was transferred to an autoclave with a Teflon liner, and heated at 150° C. for 2 days under dynamic conditions. The sample after the hydrothermal crystallization was filtered and washed with abundant distilled water, and finally dried at 100° C.

The solid was characterized by Powder X-ray Diffraction (PXRD), obtaining the characteristic PXRD pattern of the CHA material (see Example 10 in FIG. 1). The chemical analysis by XRF of the resultant solid indicates a Pt content of 0.2 wt %.

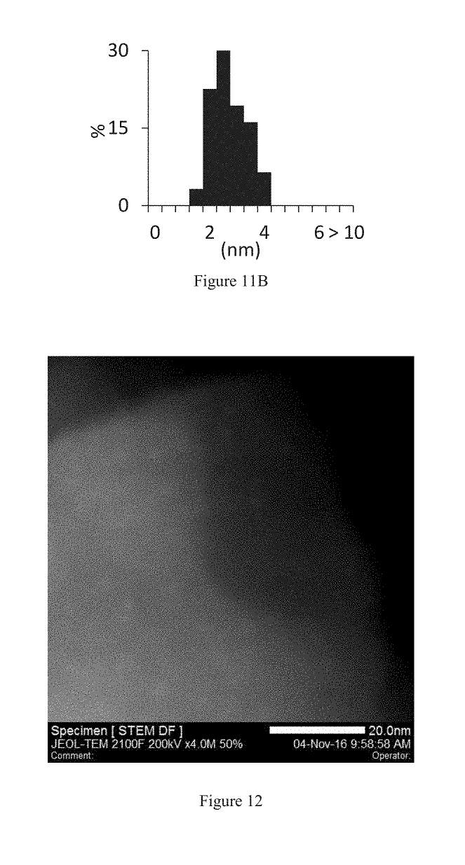

FIG. 11A shows a STEM image of the solid after being calcined at 550° C. in air and reduced with H₂ at 400° C. for 2 hours. The sample was microtomed prior to acquisition of the STEM image. The particle size distribution (diameter vs. abundance expressed as a percentage of the particles by number) for this sample is shown in FIG. 11B.

### Example 11: Pt/Pd Encapsulated in High Silica CHA Zeolite Using TMSH as Anchoring Agent

40 mg of sodium hydroxide (99 wt %, Sigma-Aldrich) was dissolved in 8 g of water. Then, 340 mg of a 1 wt % aqueous solution of chloroplatinic acid (H₂PtCl₆, 37.50 wt % Pt basis, Sigma-Aldrich), 347 mg of a 1 wt % aqueous solution of tetramminepalladium (II) chloride (Pd(NH₃)Cl₂.H₂O, 99.99° %, Sigma-Aldrich) and 63 mg of (3-mercaptopropyl)trimethoxysilane (TMSH, 95%, Sigma-Aldrich) were added to the above solution, and the mixture was stirred for 30 minutes. Afterwards, 18.13 g of an aqueous solution of N,N,N-trimethyl-1-adamantammonium hydroxide (TMAdA. 9.2 wt %) was added and maintained under stirring during 15 minutes. At that time, 234 mg of aluminum hydroxide (58 wt %, Sigma-Aldrich) was added, and the resultant mixture kept under stirring at 80° C. for 30 minutes. Finally, 6 g of colloidal silica (Ludox AS40, 40 wt %. Aldrich) was introduced in the synthesis mixture, and maintained under stirring at 80° C. for 30 minutes. The mixture was then left to cool at room temperature, and maintained under stirring for the required time to evaporate the excess of water until achieving the desired gel concentration. The final gel composition was SiO₂: 0.033 Al₂O₃: 0.00017 Pt: 0.00033 Pd: 0.005 TMSH: 0.2 TMAdA:0.4 NaOH:20 H₂O.

The gel was transferred to an autoclave with a Teflon liner, and heated at 90° C. for 7 days, and later, at 160° C. for 2 days under dynamic conditions. The sample after the hydrothermal crystallization was filtered and washed with abundant distilled water, and finally dried at 100° C.

The solid was characterized by Powder X-ray Diffraction (PXRD), obtaining the characteristic PXRD pattern of the CHA material. Elemental analysis by ICE-AES of the resultant solid indicated a Si/Al of 7.0 (SiO₂:Al₂O₃ molar ratio of 14:1) and analysis by XRF gave a Pt and Pd content of 0.09 and 0.10 wt % respectively.

The Pt/Pd-containing CHA was calcined at 550° C. in air in order to remove the organic moieties included inside the microporous material during the crystallization process.

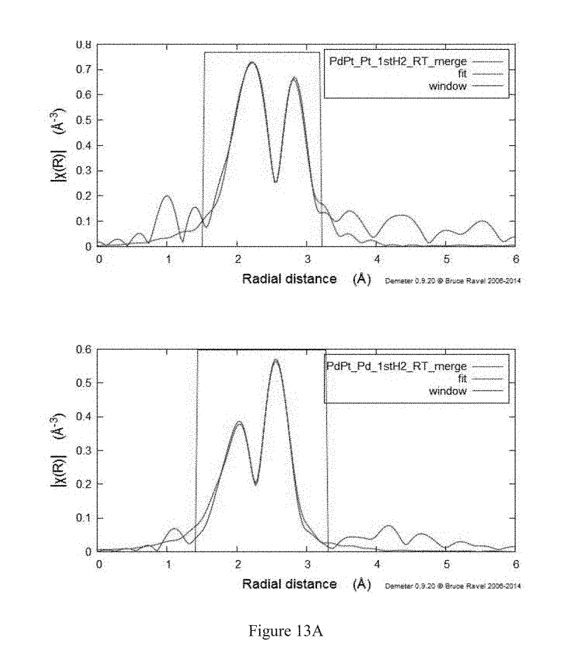

The calcined sample was treated with H₂ at 400° C. for 2 hours. STEM microscopy (see FIG. 12) reveals the formation of very small metallic nanoparticles. These metallic nanoparticles are substantially spherical and have a particle size (biggest dimension, i.e. diameter) in the range of 1 to 3 nm within the high-silica CHA structure.

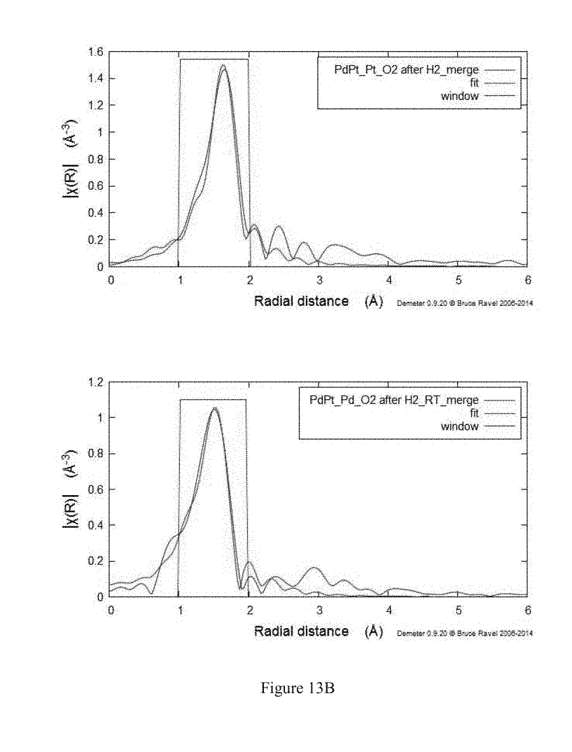

In order to examine the formation of a bimetallic Pt—Pd interaction during the H₂ treatment. EXAFS spectra were recorded after the first H₂ treatment at 400° C. The spectra (FIG. 13A) show the existence of Pt—Pt and Pt—Pd interactions in the Pt LIII-edge, and the existence of Pd—Pt and Pd—Pd interactions in the Pd K-edge, evidencing the formation of bimetallic nanoparticles.

On the other hand, EXAFS spectra of the preceding sample after subsequent treatment in O₂ at 500° C. shows the lack of Pt—Pt, Pt—Pd, Pt—O—Pt, Pt—O—Pd, and Pd—Pd, Pd—Pt, Pd—O—Pd, Pd—O—Pt moieties in the Pt and Pd edges, respectively, and the exclusive presence of Pt—O and Pd—O interaction (FIG. 13B), evidencing the formation of site-isolated single metal atoms after the high temperature oxidative treatment.

### Example 12: Pt/Fe Encapsulated in High Silica CHA Zeolite Using TMSH as Anchoring Agent

640 mg of sodium hydroxide (99 wt %, Sigma-Aldrich) was dissolved in 8 g of water. Then, 680 mg of a 1 wt % aqueous solution of chloroplatinic acid (H₂PtCl₆, 37.50 wt % Pt basis, Sigma-Aldrich) and 42 mg of (3-mercaptopropyl)trimethoxysilane (TMSH, 95%, Sigma-Aldrich) were added to the above solution, and the mixture was stirred for 30 minutes. Afterwards, 18.37 g of an aqueous solution of N,N,N-trimethyl-1-adamantammonium hydroxide (TMAdA. 9.2 wt %) was added and maintained under stirring during 15 minutes. At that time, 234 mg of aluminum hydroxide (58 wt %, Sigma-Aldrich) was added, and the resultant mixture kept under stirring at 80° C. for 30 minutes. Then, 6 g of colloidal silica (Ludox AS40, 40 wt %, Aldrich) was introduced in the synthesis mixture, and maintained under stirring at 80° C. for 30 minutes. Finally. 808 mg of a 20% wt aqueous solution of iron (III) nitrate [Fe(NO₃)₃.9H₂O, 98%, Sigma Aldrich] was added dropwise, and the synthesis mixture was maintained under stirring the required time to evaporate the excess of water until achieving the desired gel concentration. The final gel composition was SiO₂: 0.033 Al₂O₃: 0.01 Fe: 0.00033 Pt: 0.005 TMSH: 0.2 TMAdA:0.4 NaOH:20 H₂O.

The gel was transferred to an autoclave with a Teflon liner, and heated at 90° C. for 7 days, and later, at 160° C. for 2 days under dynamic conditions. The sample after the hydrothermal crystallization was filtered and washed with abundant distilled water, and finally dried at 100° C.

The solid was characterized by Powder X-ray Diffraction (PXRD), obtaining the characteristic PXRD pattern of the CHA material. Elemental analysis by ICE-AES of the resultant solid indicated a Si/Al of 8.0 (SiO₂:Al₂O₃ molar ratio of 16:1) and a Si/Fe of 56, and analysis by XRF gave a Pt content of 0.15 wt %.

The Fe—Pt-containing CHA was calcined at 550° C. in air in order to remove the organic moieties included inside the microporous material during the crystallization process.

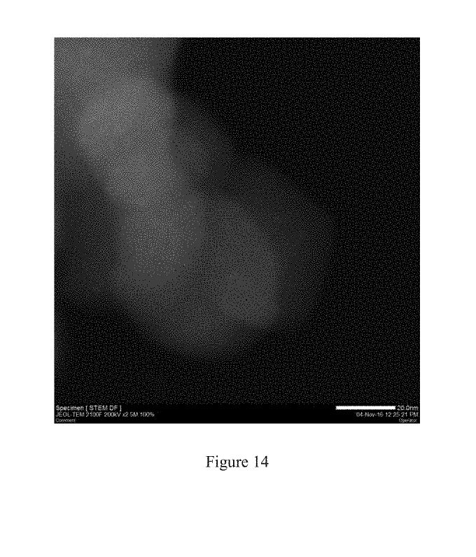

The calcined sample was treated with H₂ at 400° C. for 2 hours. STEM microscopy (see FIG. 14) reveals the formation of very small metallic nanoparticles. These metallic nanoparticles are substantially spherical and have a particle size (biggest dimension, i.e. diameter) in the range of 1 to 3 nm within the high-silica CHA structure.

### Example 13: Pt Encapsulated in a Low Si/Al Ratio LTA Zeolite—Comparative Example

A Pt-containing Al-rich LTA material was synthesized following the methodology described by M. Choi et al. (“Mercaptosilane-assisted synthesis of metal clusters within zeolites and catalytic consequences of encapsulation”, JACS, 2010, 132, 9129-9137) for comparison purposes.

First, 0.96 g of NaOH, 1.60 g of a colloidal suspension of SiO₂ (Ludox, 40% wt), and 7.2 g of water were mixed and maintained at 80° C. for 30 minutes. Afterwards, 1.2 g of NaAlO₂ and 3.6 g of water were added to the above mixture, and the resultant gel maintained under stirring at room temperature for 2 hours. The final gel composition was: SiO₂:0.7 Al₂O₃:0.002 Pt:0.06 TMSH:2.2 NaOH:60 H₂O.

The gel was transferred to an autoclave with a Teflon liner, and heated at 100° C. for 24 hours under dynamic conditions. The sample after the hydrothermal crystallization was filtered and washed with abundant distilled water, and finally dried at 100° C. After the synthesis procedure, the obtained solid showed the crystalline structure of the LTA material.

The Pt-LTA sample prepared according to the procedure described in M. Choi et al., and the calcined Pt-CHA material prepared according to the Example 1 of the present patent application, were both first subjected to a treatment with H₂ at 400° C. Then, these reduced samples were treated with steam at various temperatures, because vapor water is common in many industrial streams and is often responsible for hydrothermal degradation of the metal and/or the zeolite framework.

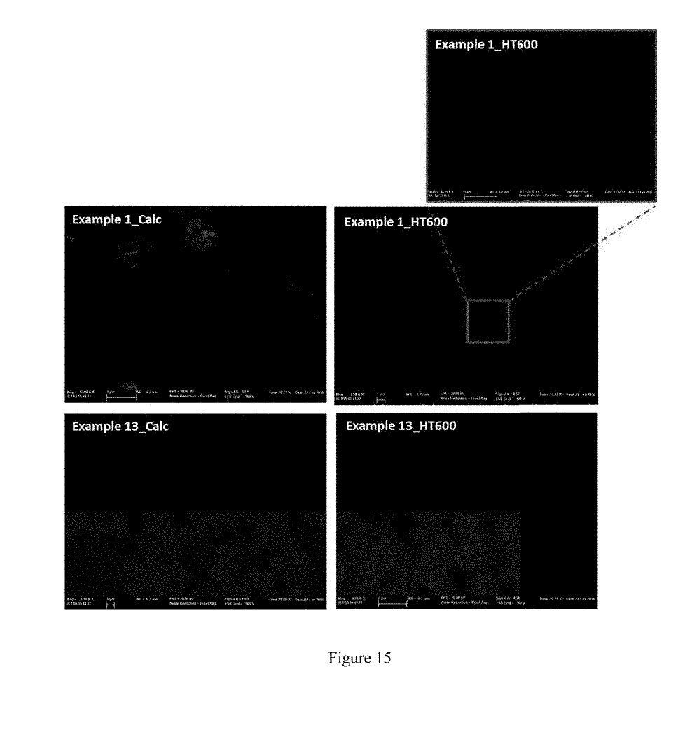

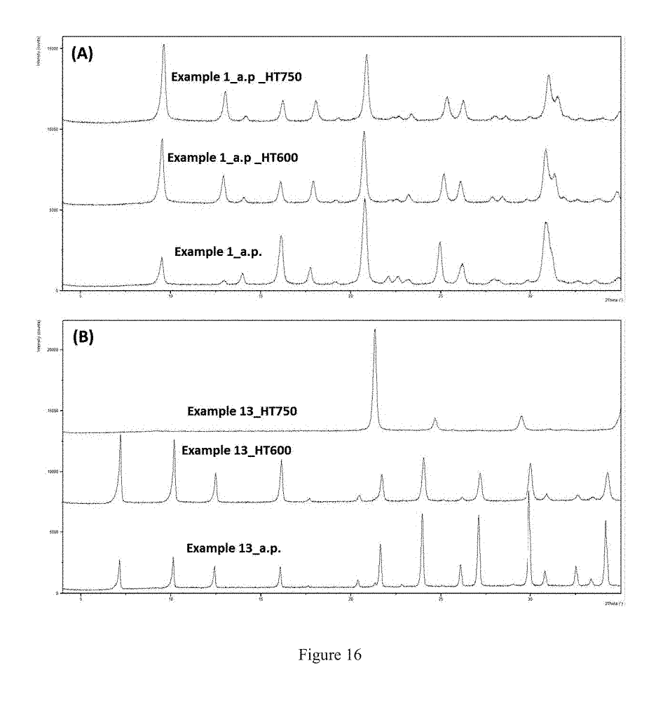

The reduced metal-containing zeolites were steamed in a muffle furnace with 100% H₂O for 4 h at 600° C. After this aging procedure, the formation of large Pt particles was not observed on the Pt-CHA sample of Example 1 (FIG. 15 top), and the crystallinity of this zeolite was retained (FIG. 16 top). In contrast, the zeolitic structure in Pt-containing Al-rich LTA zeolite collapsed under equivalent conditions, resulting in the formation of large Pt particles (FIG. 15 bottom and 16 bottom).

It will be appreciated that various presently unforeseen or unanticipated alternatives, modifications, variations or improvements therein may be subsequently made by those skilled in the art, and are also intended to be encompassed by the following claims.

The disclosures of the foregoing publications are hereby incorporated by reference in their entirety. The appropriate components and aspects of the foregoing publications may also be selected for the present materials and methods in embodiments thereof.

Additionally or alternately, the invention relates to:

### Embodiment 1

A small pore size synthetic zeolite having a degree of crystallinity of at least 80% and comprising at least 0.01 wt %, based on the weight of the zeolite, of at least one catalytic metal selected from the group consisting of Ru, Rh. Pd, Ag, Os, Ir, Pt, Au, Mo, W, Re, Co, Ni, Zn, Cr, Mn, Ce, Ga, and combinations thereof, wherein at least 80% of the catalytic metal is encapsulated in the zeolite, and wherein if the zeolite is an aluminosilicate, then the aluminosilicate has a SiO₂:Al₂O₃ molar ratio of greater than 6:1.

### Embodiment 2

The small pore size synthetic zeolite according to embodiment 1 which is an 8-membered ring zeolite, preferably of framework type AEI, AFT, AFX, CHA, CDO, DDR, EDI, ERI, IHW, ITE, ITW, KFI, MER, MTF, MWF, LEV, LTA, PAU, PWY, RHO, SFW or UFI, more preferably of framework type CHA, AEI, AFX, RHO, KFI or LTA, most preferably CHA or AFX.

### Embodiment 3

The small pore size synthetic zeolite of embodiment 1 or 2 in which the zeolite framework contains one or more elements selected from the group consisting of Si, Al, P, As, Ti, Ge, Sn, Fe, B, Ga, Be and Zn; preferably in which the zeolite framework contains at least one tetravalent element X selected from the group consisting of Si, Ge, Sn and Ti and optionally at least one trivalent element Y selected from the group consisting of Al, B, Fe and Ga; more preferably in which the zeolite framework contains at least Si and optionally Al and/or B; most preferably in which the zeolite framework contains at least Si and optionally Al.

### Embodiment 4

The small pore size synthetic zeolite of any one of the preceding embodiments which is selected from the group consisting of silicates, aluminosilicates and borosilicates, preferably from the group consisting of silicates and aluminosilicates.

### Embodiment 5

The small pore size synthetic zeolite of any one of the preceding embodiments which contains Si and Al and having a SiO₂:Al₂O₃ molar ratio of greater than 8:1, preferably greater than 10:1, more greater than 12:1, in particular greater than 30:1, more particularly greater than 100:1, most particularly greater than 150:1.

### Embodiment 6

The small pore size synthetic zeolite of any one of the preceding embodiments which further comprises at least 0.01 wt %, preferably from 0.05 to 5 wt % of a transition metal selected from the group consisting of Cu, Fe, Ti, Zr, Nb, Hf, Ta and combinations thereof, in particular wherein said transition metal is extra-framework metal.

### Embodiment 7

The small pore size synthetic zeolite of any one of the preceding embodiments having a degree of crystallinity of at least 95%.

### Embodiment 8

The small pore size synthetic zeolite of any one of the preceding embodiments which comprises from 0.05 to 5 wt % of the catalytic metal, preferably from 0.1 to 3 wt %, more preferably from 0.5 to 2.5 wt %, most preferably from 1 to 2 wt %.

### Embodiment 9

The small pore size synthetic zeolite of any one of the preceding embodiments wherein at least 80%, more preferably at least 90%, preferably at least 95%, and most preferably at least 98% of the catalytic metal is encapsulated in zeolite.

### Embodiment 10

The small pore size synthetic zeolite of any one of the preceding embodiments in which the catalytic metal is selected from the group consisting of Ru, Rh, Pd, Ag, Os, Ir, Pt, Au, Re, and combinations thereof, most preferably from the group consisting of Pt, Rh, Pd and Au and combinations thereof, in particular Pt, Pd and/or Rh.

### Embodiment 11

The small pore size synthetic zeolite of any one of the preceding embodiments wherein the catalytic metal is present in the form of particles wherein at least 80% of the particles by number have a biggest dimension of less than 4 nm as measured by TEM.

### Embodiment 12

The small pore size synthetic zeolite of any one of the preceding embodiments which is a silicate or an aluminosilicate having a SiO₂:Al₂O₃ molar ratio of greater than 6:1, preferably greater than 12:1, in particular greater than 30:1, wherein the catalytic metal is selected from the group consisting of Pt, Rh, Pd and Au and combinations thereof, preferably Pt, Pd and/or Rh, and wherein the zeolite is of framework type CHA, AEI, AFX, RHO, KFI or LTA, preferably CHA or AFX.

### Embodiment 13

The small pore size synthetic zeolite of any one of the preceding embodiments which is in as-synthesized form and further comprises a structure directing agent (SDA), in particular an organic structure directing agent (OSDA).

### Embodiment 14

The small pore size synthetic zeolite of any one of the preceding embodiments in calcined form prepared by subjecting the small pore size zeolite of embodiment 13 to a calcining step.

### Embodiment 15

A process for the preparation of the small pore size synthetic zeolite of any one of the preceding embodiments comprising:

a) providing a reaction mixture comprising a synthesis mixture capable of forming the small pore size synthetic zeolite framework and at least one catalytic metal precursor, wherein the catalytic metal precursor includes metal complexes stabilized by ligands L selected from the group consisting of N-containing ligands, O-containing ligands, S-containing ligands, and P-containing ligands,
b) heating said reaction mixture under crystallization conditions to form crystals of said small pore size synthetic zeolite, and
c) recovering said crystals of the small pore size synthetic zeolite from the reaction mixture.

### Embodiment 16

The process of embodiment 15 wherein the ligand L is a N-containing ligand, in particular an amine, preferably selected from the group consisting of NH₃ and bidentate amines and combinations thereof; more particularly selected from the group consisting of NH₃ and ethylenediamine.

### Embodiment 17

The process of embodiment 15 or 16 wherein the catalytic metal precursor is selected from the group consisting of [Pt(NH₃)₄]Cl₂, [Pt(NH₃)₄](NO₃)₂, [Pd(NH₂CH₂CH₂CH₂NH₂)₂]Cl₂, [Rh(NH₂CH₂CH₂NH₂)₃]Cl₃, [Ir(NH₃)₅Cl]Cl₂, [Re(NH₂CH₂CH₂NH₂)₂O₂]Cl, [Ag(NH₂CH₂CH₂NH₂)]NO₃, [Ru(NH₃)₆]Cl₃, [Ir(NH₃)₆]Cl₃, [Ir(NH₃)₆](NO₃)₃, [Ir(NH₃)₅NO₃](NO₃)₂.

### Embodiment 18

The process of any one of embodiments 15 to 17 wherein the synthesis mixture capable of forming the small pore size synthetic zeolite framework comprises a source of a tetravalent element X and optionally a source of a trivalent element Y, and wherein the molar ratio of the catalytic metal precursor (in terms of metal):(XO₂+Y₂O₃) in the synthesis mixture is in the range of from 0.00001 to 0.015, preferably from 0.0001 to 0.010, more preferably from 0.001 to 0.008.

### Embodiment 19

A process for the preparation of the small pore size synthetic zeolite of any one of embodiments 1 to 14 comprising:

a) providing a reaction mixture comprising a synthesis mixture capable of forming the small pore size synthetic zeolite framework, at least one anchoring agent, and at least one catalytic metal precursor, wherein the anchoring agent includes at least one amine and/or thiol group and at least one alkoxysilane group and the catalytic metal precursor includes at least one ligand capable of being exchanged by the at least one amine group and/or thiol group of the anchoring agent,
b) heating said reaction mixture under crystallization conditions to form crystals of said small pore size synthetic zeolite, and
c) recovering said crystals of the small pore size synthetic zeolite from the reaction mixture.

### Embodiment 20

The process of embodiment 19 wherein the anchoring agent is a thiol of the structure HS—(CH₂)ₓ—Si—(OR)₃, where x=1 to 5 and R=C₁ to C₄ alkyl, preferably methyl, ethyl, propyl, or butyl, most preferably x=3 and R=methyl or ethyl.

### Embodiment 21

The process of embodiment 19 wherein the anchoring agent is an amine of the structure H₂N—(CH₂)ₓ—Si—(OR)₃, where x=1 to 5 and R=C₁ to C₄ alkyl, preferably methyl, ethyl, propyl, or butyl, most preferably x=3 and R=methyl or ethyl.

### Embodiment 22

The process of any one of embodiments 19 to 21 wherein the synthesis mixture capable of forming the small pore size synthetic zeolite framework comprises a source of a tetravalent element X and optionally a source of a trivalent element Y, in which the molar ratio of anchoring agent:(XO₂+Y₂O₃) is in the range of from 0.001 to 0.02, preferably from 0.002 to 0.015.

### Embodiment 23

The process of any of embodiments 19 to 22 wherein the synthesis mixture capable of forming the small pore size synthetic zeolite framework comprises a source of a tetravalent element X and optionally a source of a trivalent element Y, and wherein the molar ratio of catalytic metal precursor (in terms of metal):(XO₂+Y₂O₃) is in the range of from 0.0001 to 0.001, preferably from 0.0002 to less than 0.001, more preferably from 0.0002 to 0.0005.

### Embodiment 24

The process of any one of embodiments 19 to 23 wherein the catalytic metal precursor is selected from the group consisting of H₂PtCl₆, H₂PtBr₆, Pt(NH₃)₄Cl₂, Pt(NH₃)₄(NO)₂, RuCl₃.xH₂O, RuBr₃.xH₂O, RhCl₃.xH₂O, Rh(NO₃)₃.2H₂O, RhBr₃.xH₂O, PdCl₂.xH₂O, Pd(NH₃)4Cl₂, Pd(NH₃)₄B₄₂, Pd(NH₃)(NO₃)₂, AuCl₃, HAuBr₄.xH₂O, HAuCl₄, HAu(NO₃)₄.xH₂O, Ag(NO₃)₂, ReCl₃, Re₂O₇, OsCl₃, OsO₄, IrBr₃.4H₂O, IrCl₂, IrCl₄, IrCl₃.xH₂O, and IrBr₄, where x is from 1 to 18, preferably from 1 to 6.

### Embodiment 25

The process of any one of embodiments 15 to 19 wherein the synthesis mixture capable of forming the small pore size synthetic zeolite framework comprises a source of a tetravalent element X and optionally a source of a trivalent element Y, optionally a source of an alkali metal M, a source of hydroxide ions and/or a source of halide ions, a source of an organic structure directing agent (OSDA), and water.

### Embodiment 26

The process of any one of embodiments 15 to 25 in which said synthesis mixture has a composition including the following molar ratios:

| | |
|---|---|
| XO₂: Y₂O₃ | 1 to ∞, preferably 1 to 100 |
| OH⁻: (XO₂ + Y₂O₃) | 0 to 1.0 |
| M⁺: (XO₂ + Y₂O₃) | 0 to 0.45 |
| SDA: (XO₂ + Y₂O₃) | 0.04 to 0.5 |
| H₂O: (XO₂ + Y₂O₃) | 1 to 100 |
| Halide−: (XO₂ + Y₂O₃) | 0 to 1 |

### Embodiment 27

The process of any one of embodiments 15 to 26 in which X is Si and Y is Al and/or B, preferably in which X is Si and Y is Al.

### Embodiment 28

The process of any one of embodiments 15 to 27 in which the crystallization conditions include heating the synthesis mixture at a temperature in the range of from 100° C. to 200° C.

### Embodiment 29

A process for the preparation of a small pore size synthetic zeolite in calcined form according to embodiment 14 which comprises subjecting the small pore size synthetic zeolite in as-synthesized form of embodiment 13 or the crystals of small pore size synthetic zeolite recovered in the process of any of embodiments 15 to 23 to a calcination step.

### Embodiment 30

The process of embodiment 29 in which the calcination step is carried out at a temperature of equal to or greater than 500° C. for a period of at least 1 hour.

### Embodiment 31

Use of an active form of the small pore size synthetic zeolite of any one of embodiments 1 to 14 as a sorbent or as a catalyst.

### Embodiment 32

A process for converting a feedstock comprising an organic compound to a conversion product which comprises the step of contacting said feedstock at organic compound conversion conditions with a catalyst comprising a small pore size synthetic zeolite of any one of embodiments 1 to 14.

### Embodiment 33

The process of embodiment 32 which is a hydrogenation process.

1-24. (canceled)

25. A small pore size synthetic zeolite having a degree of crystallinity of at least 80% and comprising at least 0.01 wt %, based on the weight of the zeolite, of at least one catalytic metal selected from the group consisting of Ru, Rh, Pd, Ag, Os, Ir, Pt, Au, Mo, W, Re, Co, Ni, Zn, Cr, Mn, Ce, Ga, and combinations thereof, wherein at least 80% of the catalytic metal is encapsulated in the zeolite, wherein if the zeolite is an aluminosilicate it has a SiO₂:Al₂O₃ molar ratio of greater than 6:1.

26. The small pore size synthetic zeolite of claim 25 having framework type CHA, AEI, AFX, RHO, KFI or LTA.

27. The small pore size synthetic zeolite of claim 25 which is selected from the group consisting of silicates, aluminosilicates and borosilicates wherein, if the zeolite contains Si and Al, it has a SiO₂:Al₂O₃ molar ratio of greater than 10:1.

28. The small pore size synthetic zeolite of claim 25, which further comprises at least 0.01 wt % of a transition metal selected from the group consisting of Cu, Fe, Ti, Zr, Nb, Hf, Ta and combinations thereof, wherein said transition metal is extra-framework metal.

29. The small pore size synthetic zeolite of claim 25, wherein the catalytic metal is present in the form of particles wherein at least 80% of the particles by number have a biggest dimension of less than 4 nm as measured by TEM.

30. The small pore size synthetic zeolite of claim 25, which is a silicate or an aluminosilicate having a SiO₂:Al₂O₃ molar ratio of greater than 12:1, wherein the catalytic metal is selected from the group consisting of Pt, Rh, Pd and Au and combinations thereof, and wherein the zeolite is of framework type CHA, AEI, AFX, RHO, KFI or LTA.

31. The small pore size synthetic zeolite of claim 25, which is a silicate or an aluminosilicate having a SiO₂:Al₂O₃ molar ratio of greater than 12:1, wherein the catalytic metal is selected from the group consisting of Pt, Pd and/or Rh, and wherein the zeolite is of framework type CHA or AFX.

32. The small pore size synthetic zeolite of claim 25, which is in as-synthesized form and further comprises an organic structure directing agent (OSDA).

33. The small pore size synthetic zeolite of claim 25 in calcined form, which is prepared by subjecting the small pore size zeolite of claim 32 to a calcining step.

34. A process for the preparation of a small pore size synthetic zeolite of claim 25 comprising the steps of:
a) providing a reaction mixture comprising a synthesis mixture capable of forming the small pore size synthetic zeolite framework and at least one catalytic metal precursor, wherein the catalytic metal precursor includes metal complexes stabilized by ligand(s) L selected from the group consisting of N-containing ligands, O-containing ligands, S-containing ligands, and P-containing ligands,
b) heating said reaction mixture under crystallization conditions to form crystals of said small pore size synthetic zeolite, and
c) recovering said crystals of the small pore size synthetic zeolite from the reaction mixture.

35. The process of claim 34, wherein the ligand(s) L is a N-containing ligand selected from the group consisting of NH₃ and ethylenediamine; and the catalytic metal precursor is selected from the group consisting of [Pt(NH₃)₄]Cl₂, [Pt(NH₃)₄](NO₃)₂, [Pd(NH₂CH₂CH₂NH₂)₂]C₂, [Rh(NH₂CH₂CH₂NH₂)₃]Cl₃, [Ir(NH₃)₅Cl]Cl₂, [Re(NH₂CH₂CH₂NH₂)₂O₂]Cl, [Ag(NH₂CH₂CH₂NH₂)]NO₃, [Ru(NH₃)₆]Cl₃, [Ir(NH₃)₆]Cl₃, [Ir(NH₃)₆](NO₃)₃, [Ir(NH₃)₅NO₃](NO₃)₂.

36. The process of claim 34, wherein the synthesis mixture capable of forming the small pore size synthetic zeolite framework comprises a source of a tetravalent element X and optionally a source of a trivalent element Y, and wherein the molar ratio of the catalytic metal precursor (in terms of metal):(XO₂+Y₂O₃) in the synthesis mixture is in the range of from 0.00001 to 0.015.

37. A process for the preparation of a small pore size synthetic zeolite of claim 25 comprising the steps of:
a) providing a reaction mixture comprising a synthesis mixture capable of forming the small pore size synthetic zeolite framework, at least one anchoring agent, and at least one catalytic metal precursor, wherein the anchoring agent includes at least one amine and/or thiol group and at least one alkoxysilane group and the catalytic metal precursor includes at least one ligand capable of being exchanged by the at least one amine group and/or thiol group of the anchoring agent,
b) heating said reaction mixture under crystallization conditions to form crystals of said small pore size synthetic zeolite, and
c) recovering said crystals of the small pore size synthetic zeolite from the reaction mixture.

38. The process of claim 36, wherein the anchoring agent is a thiol of the structure HS—(CH₂)ₓ—Si—(OR)₃, where x=1 to 5 and R=C₁ to C₄ alkyl; or an amine of the structure H₂N—(CH₂)^{x}—Si—(OR)3, where x=1 to 5 and R=C₁ to C₄ alkyl; and the catalytic metal precursor is selected from the group consisting of H₂PtCl₆, H₂PtBr₆, Pt(NH₃)₄Cl₂, Pt(NH₃)₄(NO₃)₂, RuCl₃.xH₂O, RuBr₃.xH₂O, RhCl₃.xH₂O, Rh(NO₃)_{3.2}H₂O, RhBr₃.xH₂O, PdCl₂.xH₂O, Pd(NH₃)₄Cl₂, Pd(NH₃)₄B₄₂, Pd(NH₃)(NO₃)₂, AuCl₃, HAuBr₄.xH₂O, HAuCl₄, HAu(NO₃)₄.xH₂O, Ag(NO₃)₂, ReCl₃, Re₂O₇, OsCl₃, OsO₄, IrBr_{3.4}H₂O, IrCl₂, IrCl₄, IrCl₃.xH₂O, and IrBr₄, where x is from 1 to 18.

39. The process of claim 36, wherein the synthesis mixture capable of forming the small pore size synthetic zeolite framework comprises a source of a tetravalent element X and optionally a source of a trivalent element Y, and in which the molar ratio of anchoring agent:(XO₂+Y₂O₃) is in the range of from 0.001 to 0.02; and the molar ratio of catalytic metal precursor (in terms of metal):(XO₂+Y₂O₃) is in the range of from 0.0001 to 0.001.

40. A process for use of an active form of the small pore size synthetic zeolite of claim 25 as a sorbent or as a catalyst.

41. A process for converting a feedstock comprising an organic compound to a conversion product which comprises the step of contacting said feedstock at organic compound conversion conditions with a catalyst comprising a small pore size synthetic zeolite of claim 25.
